(19) United States
(12) Patent Application Publication
(10) Pub. No.: US 2026/0153185 A1
(43) Pub. Date: Jun. 4, 2026

(54) HEIGHT-ADJUSTABLE MOUNT AND SUPPORT FOR A DISPLAY DEVICE

(71) Applicant: NINGBO TUOTUO RIVER DESIGN COMPANY, Ningbo (CN)

(72) Inventors: Hong Jun Wang, Ningbo (CN); Yu Jie Zheng, Ningbo (CN); Zhi Min Wang, Ningbo (CN); Jun Tang, Ningbo (CN)

(21) Appl. No.: 19/455,530

(22) Filed: Jan. 21, 2026

Related U.S. Application Data
(63) Continuation-in-part of application No. 18/620,149, filed on Mar. 28, 2024, now Pat. No. 12,571,496.

(30) Foreign Application Priority Data
Jul. 19, 2023 (CN) 202310889867.6
Jan. 24, 2025 (CN) 202520171997.0

(51) Int. Cl. F16M 11/04; F16M 11/42

(52) U.S. Cl. CPC F16M 11/046; F16M 11/42; F16M 2200/047; F16M 2200/08

(57) ABSTRACT

The present disclosure provides a height-adjustable mount, comprising a first frame assembly, a second frame assembly, a rotation assembly, and a balance assembly. The first frame assembly includes a first frame and a middle connecting plate coupled to the first frame. The first frame assembly is slidably disposed relative to the second frame assembly. Two rotation assemblies are symmetrically disposed along the first direction, and each rotation assembly includes a first rotating member and a second rotating member. The balance assembly includes two elastic members or assemblies symmetrically disposed along the first direction. Wherein the rotation assemblies enable the first frame to move up and down relative to the second frame and stop at any position under the action of an external force, and the elastic force generated by the elastic member or assembly, the first elastic member and the second elastic member is used to counteract the gravity of the load of the first frame.

### PRIORITY APPLICATIONS

This application is a continuation-in-part of U.S. application Ser. No. 18/620,149, filed Mar. 28, 2024, which claims priority to CN App. No. 202310889867.6, filed Jul. 19, 2023. This application also claims priority to CN App. No. 202520171997.0, filed Jan. 24, 2025. Each of these applications is incorporated by reference in its entirety and for all purposes. Any and all applications for which a foreign or domestic priority claim is identified in the Application Data Sheet as filed with the present application are hereby incorporated by reference under 37 CFR 1.57.

### BACKGROUND

### Field

This present disclosure relates to display (e.g., televisions, computer monitors, etc.) mounting equipment, and in particular, to a height-adjustable mount for a television or other display.

### Description

To save space, displays, such as touch screens, flat-panel televisions, or others, are often fixed to or mounted on a wall or other generally vertical surface. Once the installation is complete, the installation height of the display is not adjustable, which can result in poor user experience due to the different needs of the users. Take a touch screen as an example, the fixed position of the touch screen cannot meet the operational needs of all users. For instance, some underage children are short, and cannot operate the touch screen installed in line with the height of the adult position. Flat-panel televisions provide another example, with most users choosing to mount the television on the wall using a wall mount that provides the advantage of occupying a small space (e.g., a low-profile mount). When different people watch the television, the center of the television's height and the eye level of the viewers may not be at the same level because the height of the television cannot be adjusted, which can result in a poor and uncomfortable viewing experience.

### SUMMARY

In some instances, a purpose of the present disclosure is to provide a height adjustable mount that allows for the height of the display to be adjusted after it is installed through the mount, so as to meet the operation or viewing needs of different users.

In one example, a height-adjustable mount can include: a first frame assembly, a second frame assembly, a rotating assembly, and a balance assembly; wherein the first frame assembly is slidably disposed relative to the second frame assembly; the first frame assembly comprises a first frame and a middle connecting plate coupled to the first frame; the rotation assembly includes a first rotating member and a second rotating member, wherein one end of the first rotating member rotationally couples with the bottom of the second frame assembly, wherein the other end of the first rotating member rotationally couples with one end of the second rotating member, and the other end of the second rotating member rotationally couples with the middle connecting plate; the balance assembly includes an elastic member or assembly, the upper end of the elastic member or assembly is coupled to the top of the second frame assembly, wherein the lower end of the elastic member or assembly is coupled to the first rotating member.

In some embodiments, the connection point of the lower end of the elastic member or assembly and the first rotating member is located between the two ends of the first rotating member.

In some embodiments, the rotation assembly is symmetrically disposed in two groups along the first direction L, the balance assembly includes two elastic member or assemblies symmetrically disposed along the first direction L, and there is a one-to-one correspondence between the rotation assembly and the elastic member or assemblies.

In some embodiments, the balance assembly further includes a first elastic member; wherein one end of the first elastic member connects to the first rotating member, and the other end of the first elastic member connects to the second frame assembly; and/or, wherein the balance assembly further includes a second elastic member, wherein one end of the second elastic member connects to the second rotating member, and the other end of the second elastic member connects to the middle connecting plate.

In some embodiments, the balance assembly further includes a connecting member, and the first rotating member includes a protruding portion disposed along the width direction of the first rotating member; the second frame assembly includes a second frame and a first connecting plate disposed at the bottom of the second frame; the first connecting plate is provided with a rotating shaft that is located above the protruding portion; the connecting member is provided around the second rotating shaft; one end of the connecting member is coupled to the elastic member or assembly, and the other end of the connecting member is coupled to the protruding portion; the connecting member may be a chain or a rope.

In some embodiments, the connecting member is a chain, and a second rotating shaft is provided with a gear; the chain is disposed around a gear and meshes with the gear.

In some embodiments, the balance assembly further includes a connecting member, the connecting member is a chain, one end of the connecting member is coupled to the elastic member or assembly, and the other end of the connecting member is coupled to the first rotating member, the chain is disposed around a gear and meshes with the gear, the gear is provided on the second frame assembly.

In some embodiments, the height-adjustable mount further includes a first adjusting screw symmetrically disposed used for adjusting the stretched length of the elastic member or assembly; the elastic member or assembly is coupled to the top of the second frame through one corresponding first adjusting screw.

In some embodiments, the first frame is provided with a guide rail parallel to the middle connecting plate; the second frame is provided with a side wheel; and the guide rail cooperates with the side wheel to allow the first frame assembly to slide relative to the second frame assembly.

In some embodiments, the side wheels are arranged in two columns along the sliding direction of the first frame assembly, every other center of the circles of the two columns of the side wheels is aligned, and each column of side wheels respectively cooperates with a front sidewall or a rear sidewall of the guide rail.

In some embodiments, the height-adjustable mount further includes a second adjusting screw; wherein the second frame assembly is provided with an assembly section disposed above the connection joint of the first rotating member and the second frame assembly; one end of the second adjusting screw is rotationally coupled to the assembly section, and the other end is coupled to the first elastic member, adjusting the second adjusting screw to retract or extend the first elastic member.

In some embodiments, the first frame is provided with two stop portions that are disposed at the top and bottom of the first frame; the bottom of the second frame is provided with a fitting section for cooperating with the stop portion so that controlling the sliding distance of the first frame.

In some embodiments, the height-adjustable mount further includes a front cover disposed in the front side of the second frame assembly; the front cover is provided with a first window at a position corresponding to the elastic member or assembly; the front cover comprising a first scale at a position proximate to the first window in the direction of extension of the first window.

In some embodiments, the height-adjustable mount further includes a second connecting plate that snapped in front of the first frame assembly, and the edges of the second connecting plate are fixedly coupled to the second frame assembly; the second connecting plate includes at least two guide wheels; the guide wheels are disposed on two sides of the middle connecting plate, and the circumferential walls of the guide wheels can be contacted with two sides of the middle connecting plate.

In some embodiments, the second connecting plate is provided with a second window at a position corresponding to the first elastic member; the first elastic member includes a second indicator at a position corresponding to the second window, and the second connecting plate is provided with a second scale at a position near the second window along the extension direction of the second window.

Embodiments of the present disclosure can provide a height-adjustable mount with a simple and low-profile structure that can provide stable and smooth up and down movement of a display mounted thereto. Some embodiments can include a rotation assembly that is symmetrically disposed in two groups, such that when the rotation assembly drives a middle connecting plate to move, a first frame is subjected to a more uniform force and slides up and down more smoothly relative to a second frame assembly. A second rotating member and the first rotating member can be rotationally coupled; the first rotating member is rotationally coupled to the second connecting plate; the second rotating member is rotationally coupled to the middle connecting plate. Thereby the rotating assembly can be moved in a direction in which the angle between the two is gradually reduced under the action of an external force, or can be moved in a direction in which the angle between the two is gradually increased under the action of an external force. Therefore, the height of the equipment hanging on the mount can be changed through the up and down movements of the first frame, so that meeting more needs. The elastic member or assembly is capable of generating a reverse force in the opposite direction of movement, making the display balanced and stably positioned at any height through the balance assembly. As the first frame assembly is disposed to slide relative to the second frame assembly, the first frame can slide up and down relative to the second frame assembly under the driving of the rotation assembly, and can be stably positioned at any height as required under the action of the balance assembly.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a diagram of the overall structure of the height-adjustable mount provided by an embodiment of the present disclosure;

FIG. 2 is an exploded view of the height-adjustable mount of FIG. 1;

FIG. 3a is a diagram of the first frame assembly from the view facing the second frame assembly;

FIG. 3b is an enlarged view of part I of FIG. 3a;

FIG. 4 is a diagram of the first frame assembly at the highest position;

FIG. 5 is a diagram of the first frame assembly at the lowest position;

FIG. 6 is a cutaway view of the first frame assembly at the highest position;

FIG. 7 is a cutaway view of the first frame assembly at the lowest position;

FIG. 8 is an enlarged view of part B of FIG. 2;

FIG. 9 is an enlarged view of part A of FIG. 2;

FIG. 10 is a diagram showing the connecting structure of the elastic portion;

FIG. 11 is an exploded view of the connecting structure of the elastic portion of FIG. 10;

FIG. 12 is the other schematic view of the first frame assembly at the highest position;

FIG. 13 is an enlarged view of part C of FIG. 12;

FIG. 14 is the other schematic view of the first frame assembly at the lowest position;

FIG. 15 is an enlarged view of part D of FIG. 14;

FIG. 16 is the other schematic view of the overall structure of the height-adjustable mount provided by an embodiment of the present disclosure;

FIG. 17 is an enlarged view of part E of FIG. 16;

FIG. 18 is an enlarged view of part F of FIG. 16;

FIG. 19 is a diagram of the first elastic member;

FIG. 20 shows a structural diagram of an embodiment of a support for a display device;

FIG. 21 shows a rear view of the support for a display device of FIG. 20;

FIG. 22 shows an exploded structural diagram of the support for a display device of FIG. 21;

FIG. 23 shows an internal structural diagram of the support for a display device of FIG. 20 in which a support assembly is in a highest position;

FIG. 24 shows a partial structural diagram of the support for a display device of FIG. 20;

FIG. 25 shows a partial structural diagram of the support for a display device of FIG. 20;

FIG. 26 shows a partial structural diagram of the support for a display device of FIG. 20;

FIG. 27 shows an exploded diagram of a partial structure of the support for a display device of FIG. 20;

FIG. 28 shows a mating structural diagram of a guide member and a sliding member of the support for a display device of FIG. 20;

FIG. 29 shows an exploded structural diagram of the guide member and the sliding member of the support for a display device of FIG. 28;

FIG. 30 shows a structural diagram of the support for a display device of FIG. 20 in which the first frame assembly is in a higher position and a lower position;

FIG. 31 shows a structural diagram of another embodiment of a support for a display device;

FIG. 32 shows an enlarged view of H in FIG. 31;

FIG. 33 shows a structural diagram of another embodiment of a support for a display device;

FIG. 34 shows an exploded structural diagram of the support for a display device of FIG. 33;

FIG. 35 shows an exploded diagram of a partial structure of the support for a display device of FIG. 33;

FIG. 36 shows a structural diagram of another view of the structure of FIG. 35;

FIG. 37 shows an exploded structural diagram of a rotation assembly and an adjusting mechanism of the support for a display device of FIG. 33;

FIG. 38 shows a partial structural diagram of the support for a display device of FIG. 33 (The first frame assembly is in a lowest position);

FIG. 39 shows a partial structural diagram of the support for a display device of FIG. 33; and

FIG. 40 shows a structural diagram of another embodiment of a support for a display device in which a top end of the elastic member or assembly is coupled by a hook.

### DETAILED DESCRIPTION

The technical solutions in the embodiments of the present disclosure will be described below with reference to the attached drawings. The described embodiments are only some of the embodiments of the present disclosure, rather than all the embodiments. Based on the described and illustrated embodiments in the present disclosure, all other embodiments obtained by those of ordinary skill in the art based on this present disclosure fall within the protection scope of the present disclosure.

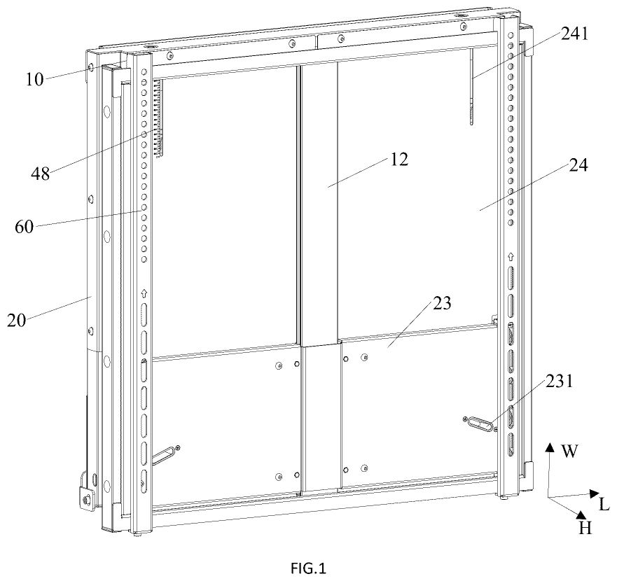

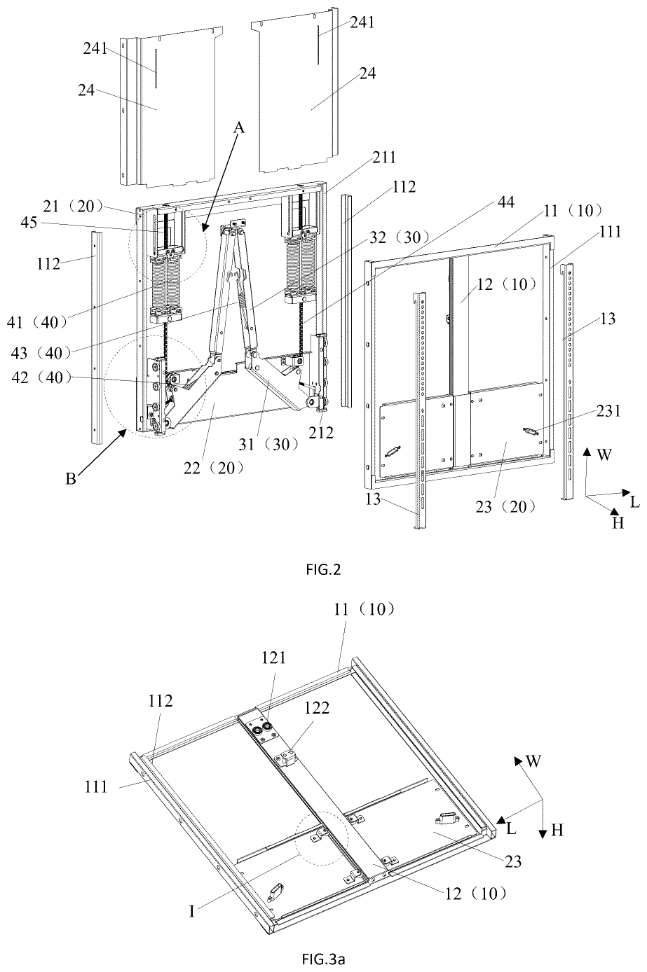

A height-adjustable mount is provided as shown in FIG. 1 and FIG. 2, comprising a first frame assembly 10, a second frame assembly 20, a rotation assembly 30, and a balance assembly 40. The first frame assembly 10 is slidably disposed relative to the second frame assembly 20. That is, the first frame assembly 10 is coupled to the second frame assembly 20 such that the first frame assembly 10 can slide or move relative to the second frame assembly 20. The first frame assembly 10 includes a first frame 11 and a middle connecting plate 12 that connects to the first frame 11. In the illustrated embodiment, the rotation assembly 30 is symmetrically disposed in two groups along the first direction, and each group of the rotation assembly 30 includes a first rotating member 31 and a second rotating member 32. One end of the first rotating member 31 rotationally couples with the bottom of the second frame assembly 20. The other end of the first rotating member 31 rotationally couples with the second rotating member 32. The upper end of the second rotating member 32 rotationally couples with the middle connecting plate 12. The balance assembly 40 includes two elastic members or assemblies 41 symmetrically disposed along the first direction L. The upper end of each elastic member or assembly 41 is coupled to the top of the second frame assembly 20, and the lower end of each elastic member or assembly 41 is coupled to the respective corresponding first rotating member 31, and the connection point of the lower end of the elastic member or assembly 41 and the first rotating member 31 is located between the two ends of the first rotating member 31.

In the illustrated embodiment, the first direction L is a direction perpendicular to the sliding direction, and the second direction W is the sliding direction, specifically the first direction L and second direction W are the length and width directions of the height-adjustable mount respectively, and the third direction H is the thickness direction of the height-adjustable mount. The second frame assembly 20 is used for mounting on a wall, and the first frame 11 is used for mounting a device to be lifted, such as a display screen that may be but is not limited to, a flat-panel display, a touch screen, or others. A connection is established between the first frame assembly 10 and the second frame assembly 20 by using the rotation assembly 30 and the balance assembly 40. The rotation assembly 30 is symmetrically provided in two groups, such that when the rotation assembly 30 drives the middle connecting plate 12 to move, the first frame 11 is subjected to a more uniform force and slides up and down more smoothly relative to the second frame assembly 20. The second rotating member 32 and the first rotating member 31 are rotationally coupled, and the first rotating member 31 is rotationally coupled to the second frame assembly 20, and the second rotating member 32 is rotationally coupled to the middle connecting plate 12, so that the rotating assembly 30 can be moved in a direction in which the angle between the two is gradually reduced under the action of an external force, or can be moved in a direction in which the angle between the two is gradually increased under the action of an external force. Therefore, the first frame 11 realizes the up or down movement to change the height of the mounted device to meet the needs of different users. The elastic member or assembly 41, which can be for example, a spring, is capable of generating a reverse force in the opposite direction of movement, making the display balanced and stably positioned at any height through the balance assembly 40. As the first frame assembly 10 is disposed to slide relative to the second frame assembly 20, the first frame 11 can slide up and down relative to the second frame assembly 20 under the driving of the rotation assembly 30, and can be stably positioned at any height as required under the action of the balance assembly 40.

The height-adjustable mount provided by the embodiments of the present disclosure features a simple structure and easy operation, which adjusts the first frame 11 relying on the rotation assembly 30, and keeps it stable by the balance assembly 40. As shown in FIG. 2, the elastic member or assembly 41 is distributed on both sides of the rotation assembly 30, which can reasonably utilize the space between the first frame assembly 10 and the second frame assembly 20, so, in some embodiments, that the orthographic projections of the two in the third direction H do not overlap, and thus the thickness of the height-adjustable mount can be further reduced.

In the illustrated embodiment, the middle connecting plate 12 is disposed in the middle of the first frame 11 and extends along the second direction W. The first frame 11 includes two mounting brackets 13, the mounting brackets 13 are disposed on a side of the first sidewall 111 of the first frame 11 away from the second frame assembly 20. The first sidewall 111 consists of two sides that extend along the second direction W of the first frame 11. The mounting brackets 13 are used to support the device to be lifted. The first rotating member 31 and the second rotating member 32 are disposed one above the other along the second direction W.

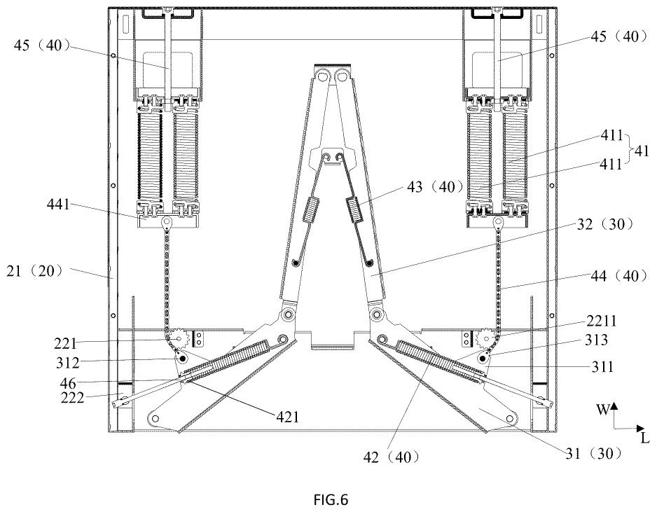

Further, as shown in FIGS. 6 and 7, the balance assembly 40 comprises two first elastic members 42, which can be, for example, springs. A first end of each first elastic member 42 can be coupled to a corresponding first rotating member 31, and a second end of each first elastic member 42 can be coupled to a corresponding second frame assembly 20. In other embodiments, the balance assembly 40 also comprises two second elastic members 43 (e.g., springs), and the lower end of each second elastic member 43 is coupled to a corresponding second rotating member 32, and the upper end of each second elastic member 43 is coupled to the middle connecting plate 12.

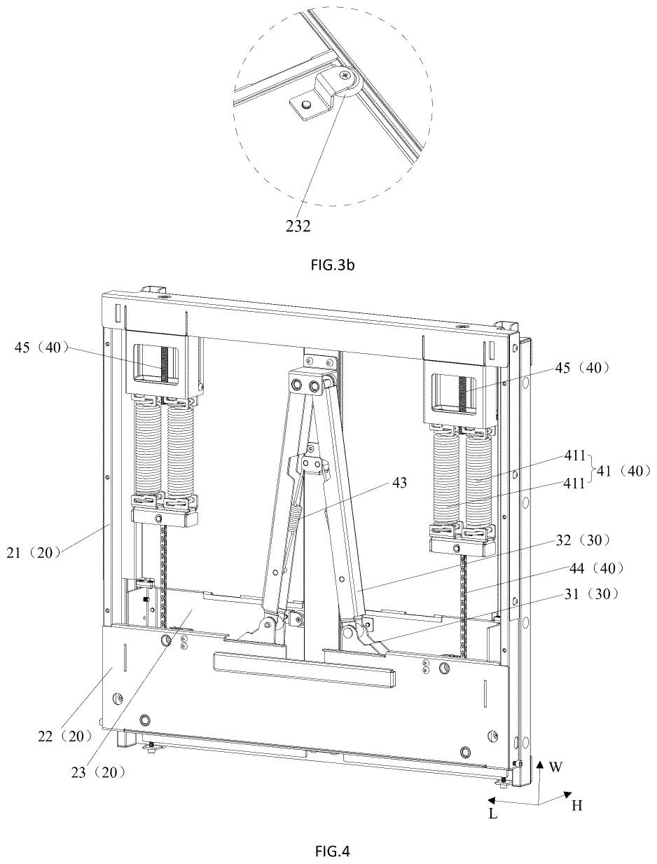

Specifically, as shown in FIGS. 3a, 7, and 8, such rotational connection of the second rotating member 32 and the middle connecting plate 12, for example, may be a hinged connection, namely the second rotating member 32 is secured to the middle connecting plate 12 by a second hinge point 121. The second elastic member 43 and the middle connecting plate 12 may also be rotationally coupled, for example, may be hinged, namely the second elastic member 43 is secured to the middle connecting plate 12 by a second hinge point 122. The first elastic member 42 and the second elastic member 43 may be springs.

In this embodiment, the first elastic member 42 and the second elastic member 43 are capable of respectively and effectively lifting and pulling the first rotating member 31 and the second rotating member 32, so that the first elastic member 42 and the second elastic member 43 together with the elastic member or assembly 41 can counteract the gravity or weight of the load to be hung by the height-adjustable mount. The elastic member or assembly 41 together with the first elastic member 42 and the second elastic member 43 generate an elastic force for counteracting the gravity or weight of the load of the first frame 11, which further enhances the weight capacity of the height-adjustable mount for a smooth and steady height adjustment.

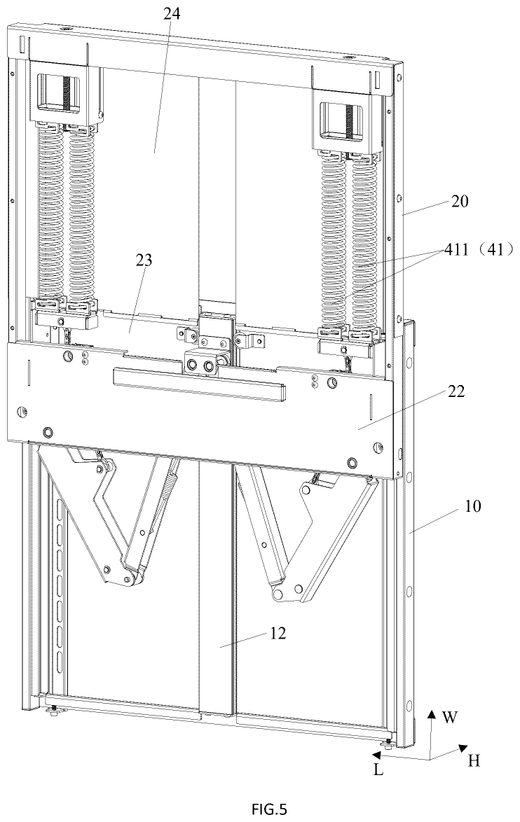

In some embodiments, as shown in FIGS. 3-7, the balance assembly 40 further includes a connecting member 44, and the first rotating member 31 includes a protruding portion 311 disposed along the width direction of the first rotating member 31. The second frame assembly 20 includes a second frame 21 and a first connecting plate 22 disposed at the bottom of the second frame 21. The first connecting plate 22 is provided with a second rotating shaft 221 that is located above the protruding portion 311. The connecting member 44 is provided around the second rotating shaft 221, and one end of the connecting member 44 is coupled to the elastic member or assembly 41, and the other end of the connecting member 44 is coupled to the protruding portion 311. The connecting member 44 may be, for example, a chain or a rope.

In this embodiment, the setting of connecting member 44 and second rotating shaft 221 allows the tension of the elastic member or assembly 41 to always remain in a vertical direction, and connecting member 44 changes direction after passing through the second rotating shaft 221, which facilitates the formation of a tension force on the first rotating member 31 and allows the connecting member 44 to always remain tensioning so that provides effective pulling on the first rotating member 31. See, for example, FIG. 7.

As a feasible approach, as shown in FIGS. 6 and 7, the connecting member 44 may be a chain, rope, or other similar tensile member. Either the chain or the rope is easy to change direction, and the change in direction is all tension on the second rotating member 32.

As shown in the illustrated embodiment of FIGS. 6-8, the connecting member 44 is a chain, and the second rotating shaft 221 is provided with a gear 2211. The chain is disposed around and meshed with the gear 2211.

In this embodiment, the chain meshes with the gear 2211 for better smoothness and strength, avoiding sliding friction and reducing damage.

Further, in the illustrated embodiment, the protruding portion 311 is provided with a first rotating shaft 312, and the connecting member 44 and the protruding portion 311 are rotationally connected by the first rotating shaft 312.

As shown in FIGS. 6-8, a chain and the first rotating shaft 312 can be rotationally connected by a cam 313, which can allow for a reduction in the size of the cam 313 and reduce the risk of interfering with other components while having enough space to set up a connection hole for installing the chain.

As a specific feasible way, as shown in FIGS. 1-7, one end of the first rotating member 31 is rotationally connected to the first connecting plate 22, and the other end of which is rotationally connected to the second rotating member 32. The upper end of the second rotating member 32 is rotationally connected to the middle connecting plate 12. The balance assembly 40 comprises two elastic members or assemblies 41, two first elastic members 42 and two second elastic members 43 symmetrically disposed along the first direction L. Along the second direction W, the upper end of each elastic member or assembly 41 is connected to the top end of the second frame 21, and the lower end of which is connected to a corresponding first rotating member 31. One end of each first elastic member 42 is connected to a corresponding first rotating member 31, and the other end of which is connected to the first connecting plate 22. The lower end of each second elastic member 43 is connected to a corresponding second rotating member 32, and the upper end of which is connected to the middle connecting plate 12.

In some embodiments, as shown in FIGS. 4-7, the height-adjustable mount further comprises two first adjusting screws 45 symmetrically disposed along the first direction L. Each elastic member or assembly 41 is connected to the top of the second frame 21 through one corresponding first adjusting screw 45, and the top of the first adjusting screw 45 is threadedly connected to the top of the second frame 21.

In this embodiment, the first adjusting screw 45 is threaded to the top of the second frame 21, and the stretching length of the elastic member or assembly 41 can be adjusted by screwing it in or out to accommodate displays of different weights.

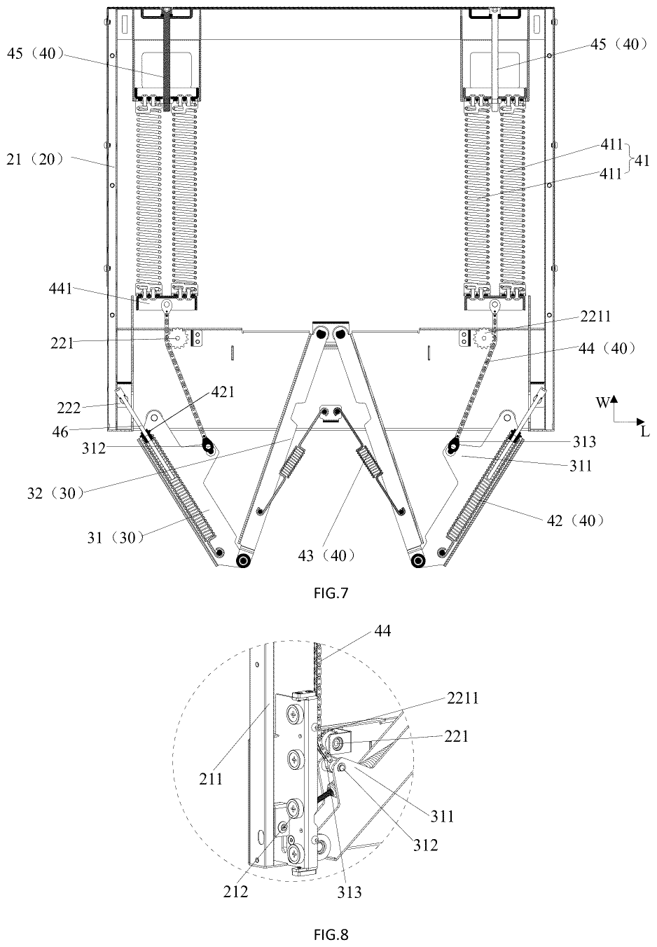

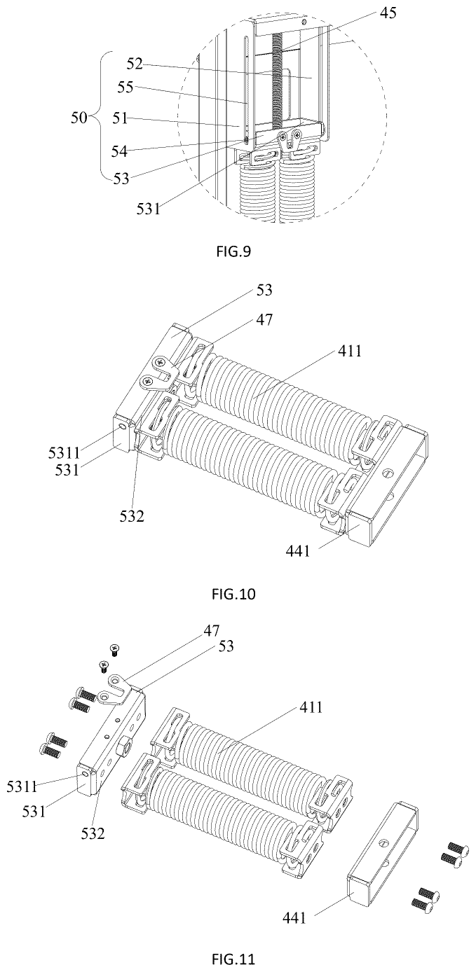

In some embodiments, as shown in FIG. 2 and FIGS. 9-11, the height-adjustable mount further comprises two stop assemblies 50 disposed corresponding to two first adjusting screws 45. Each stop assembly 50 includes a first baffle 51 and a second baffle 52 set with a gap along the first direction L, as well as a stop connecting element 53 and a stop pin 54 connected to the bottoms of the first baffle 51 and the second baffle 52. The first baffle 51 and second baffle 52 are fixed to the second frame 21. Each stop connecting element 53 includes two third sidewalls 531 provided in parallel with the first baffle 51 and the second baffle 52, and a bottom wall 532 connected to the two third sidewalls 531. The first adjusting screw 45 is threadedly connected to the bottom wall 532, and the elastic member or assembly 41 is fixed to the bottom wall 532. Two third sidewalls 531 are provided with pin holes 5311, the first baffle 51 and the second baffle 52 are provided with sliding slots 55 connected to the pin holes 5311. Passing through pin holes 5311 and sliding slots 55, the stop pins 54 restrict the movement of the elastic members or assemblies 41 by controlling the movement of the stop connecting elements 53.

In this embodiment, the stop assembly 50 is provided for restricting the movement of the elastic member or assembly 41, so that the elastic member or assembly 41 does not move together with the first adjusting screw 45 during the adjustment process, facilitating the adjustment of the first adjusting screw 45, wherein the first baffle 51 and the second baffle 52 are fixed to the second frame 21, and it can be that the tops of the first baffle 51 and the second baffle 52 are coupled to the top of the second frame 21.

In some embodiments, each elastic member or assembly 41 comprises at least two third elastic members 411, both upper ends of third elastic members 411 being coupled to the bottom wall 532, and lower ends of third elastic members 411 being coupled to the connecting member 44.

In this embodiment, the elastic member or assembly 41 comprises two or more third elastic members 411, which can be, for example, springs, which can increase the resultant force of the elastic member or assembly 41 and the weight capacity of the height-adjustable mount. Therein, the bottom of the third elastic member 411 may connect to the connecting member 44 with the help of a connecting adaptor 441, namely, both of the third elastic members 411 are coupled to the top end of the connecting adaptor 441, and the connecting member 44 is coupled to the bottom end of the connecting adaptor 441, and specifically, the connecting adaptor 441 may be a bar-shaped block. The connection between two or more third elastic members 411 and the connecting member 44 by the connecting adaptor 441 facilitates keeping the elasticity direction of all third elastic member 411 the same and vertical, which can maximize the resultant force of the plurality of elastic members so that effectively stretch the connecting member 44.

It will be appreciated that the third elastic member 411 may be a spring. The elastic member or assembly 41 may also have only one third elastic member 411. When the elastic member or assembly 41 has only one third elastic member 411, the third elastic member 411 could be directly coupled to the connecting member 44.

In some embodiments, as shown in FIGS. 2 and 3, the first frame 11 is provided with guide rails 112 parallel to the middle connecting plate 12. The second frame 21 is provided with two groups of side wheels 212, and each guide rail 112 cooperates with one group of side wheels 212 to allow the first frame assembly 10 to slide relative to the second frame assembly 20.

In this embodiment, side wheels 212 define the left-right offset of guide rails 112 by the cooperation between, which ensures the first frame 11 slides relative to the second frame 21 following the established route and prevents the sliding trajectory from being offset. When the first frame assembly 10 slides relative to the second frame assembly 20, the friction and damages can be further reduced because of the small contact area between them, which ensures a longer use life.

Specifically, as shown in FIG. 3, the guide rails 112 are disposed on one side of the first frame 11 near the second frame 21 and on the inside of the first sidewall 111. The first sidewalls 11 are two sidewalls of the first frame 11 extending in the second direction W, and the inside of the first sidewall 111 means that it is disposed in the inside of the first frame 11 and close to the first sidewall 111. The second frame 21 is provided with side wheels 212 on a side near the first frame 11, and the side wheels 212 are disposed on the two second sidewalls 211 of the second frame 21 opposite the first frame 11. The opening direction of a guide rail 112 faces the opposite side of the first sidewall 111, namely the guide rail 112 cooperates with the side wheel 212 along the first direction L, which is conducive to reducing the thickness of the height-adjustable mount

It should be noted that the present disclosure is not limited to the side wheel 212 for the structure that cooperates with the guide rail 112, but can also be provided with an elongated projection, as long as it can cooperate with the guide rail 112 to play a limiting role.

More preferably, each group of side wheels 212 is arranged in two columns along the sliding direction of the first frame assembly 10, every other center of the circle of the two columns of the side wheels 212 is aligned, and each column of the side wheels 212 respectively cooperates with a front sidewall or a rear sidewall of the guide rail 112.

In this embodiment, the side wheels 212 are arranged in two columns along the sliding direction that is the second direction W. Two adjacent side wheels 212 are not in the same column, and each column of side wheels 212 matches with the guide rail 112, allowing the front and rear sidewall of the guide rail to be in contact with the side wheels 212 so that reduces wobbling during the up and down sliding of the first frame assembly 10.

In some embodiments, as shown in FIGS. 6 and 7, the second frame assembly 20 is provided with the assembly section 222 disposed above the connection of the first rotating member 31 and the second frame assembly 20. The first elastic member 42 is rotationally coupled to the assembly section 222. The height-adjustable mount further includes a second adjusting screw 46. One end of the second adjusting screw 46 is rotationally coupled to the assembly section 222, and the other end is coupled to the first elastic member 42, adjusting the second adjusting screw 46 to retract or extend the first elastic member 42.

In this embodiment, the first elastic member 42 is coupled to the second frame assembly 20. The second frame assembly 20 is provided with assembly sections 222 above the connection joint of the second rotating member 32 and the second frame assembly 2, so that the partial force of the first elastic member 42 can counteract a part of the gravity or weight of the device to be mounted, and make a contribution to the force balance of the height-adjustable mount. The arrangement of the second adjusting screw 46 allow the length of the first elastic member 42 being adjustable, which is helpful for adapting different weights of the equipment to be lifted, and improves the applicability of the height-adjustable mount.

In some embodiments, the first connecting plate 22 of the second frame assembly 20 is provided with assembly sections 222. The first elastic member 42 is externally or internally secured with a threaded sleeve 421. The second adjusting screw 46 threadedly couples to a threaded sleeve 421, enabling the second adjusting screw 46 to be screwed in or screwed out along the axial direction of the threaded sleeve 421, thereby adjusting the length of the first elastic member 42.

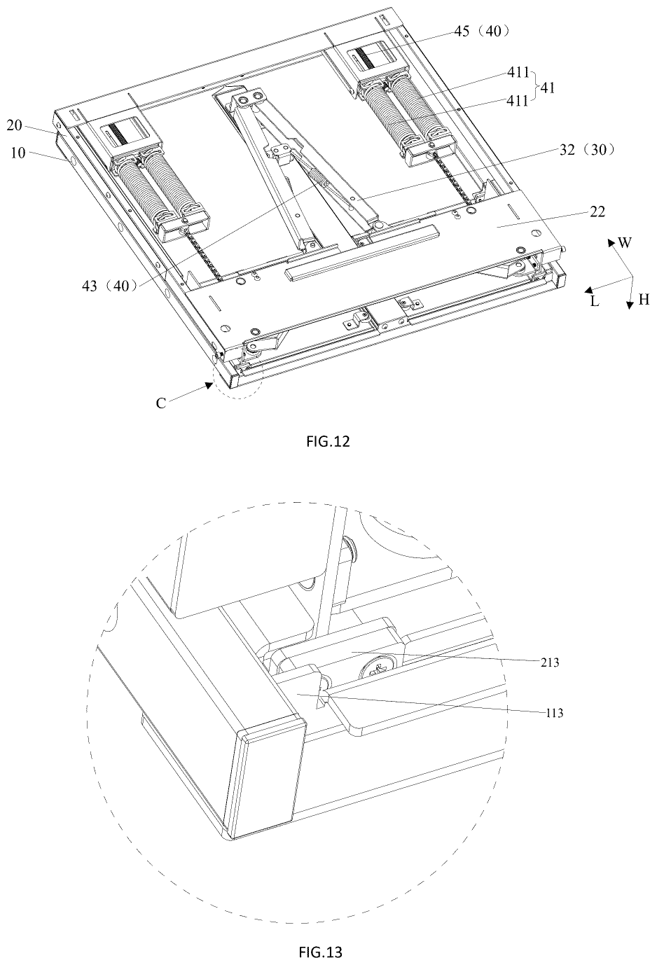

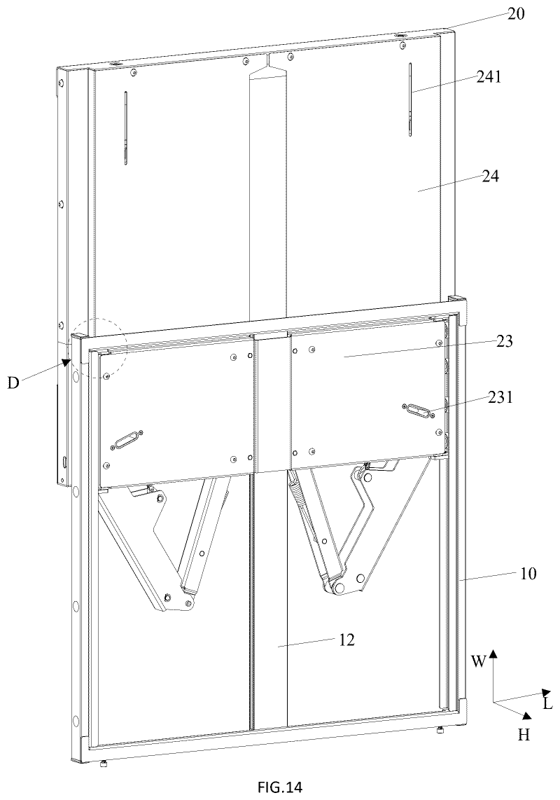

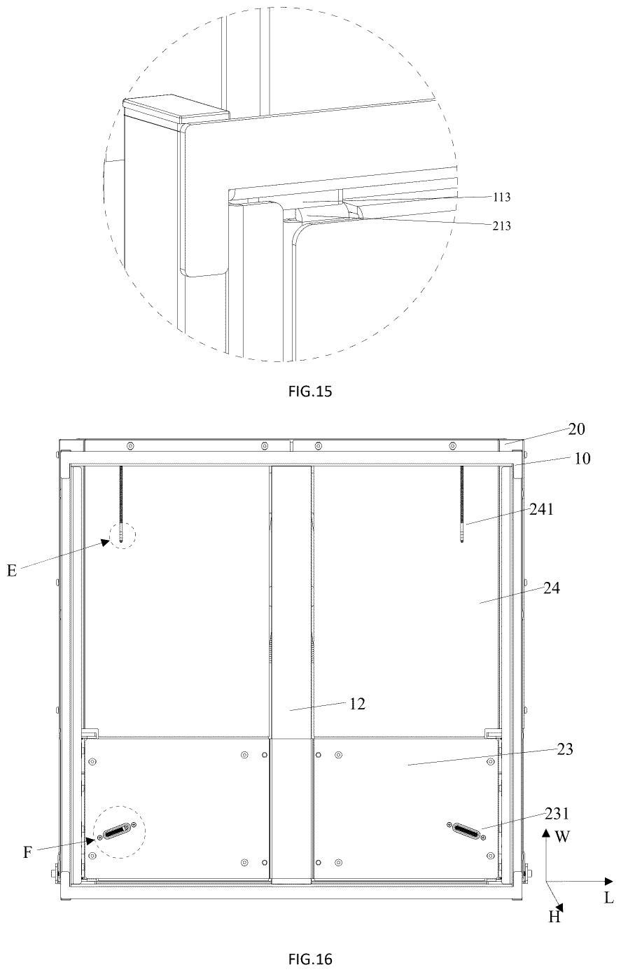

In some embodiments, for example, as shown in FIGS. 12-15, the first frame 11 is provided with two stop portions 113 that are disposed at the top and bottom of the first frame 11. The bottom of the second frame 21 is provided with a fitting section 213 for cooperating with the stop portion 113 so that controlling the sliding distance of the first frame 11.

In this embodiment, the first frame 11 and the second frame 21 are provided with the stop portion 113 and fitting section 213. When they work together, they can stop the first frame 11 from continuing to slide and prevent the first frame 11 from sliding out of the permissible range otherwise may cause unnecessary damage.

For example, the stop portion 113 may be a stop block and the fitting section 213 may be a stop step, or the stop portion 113 may be a stop step and the fitting section 213 may be a sliding slot 55 or a pin hole 5311. Conversely, the stop portion 113 may be a sliding slot 55 or a pin hole 5311 and the fitting section 213 may be a stop step, as long as their cooperation can stop the movement of the first frame 11.

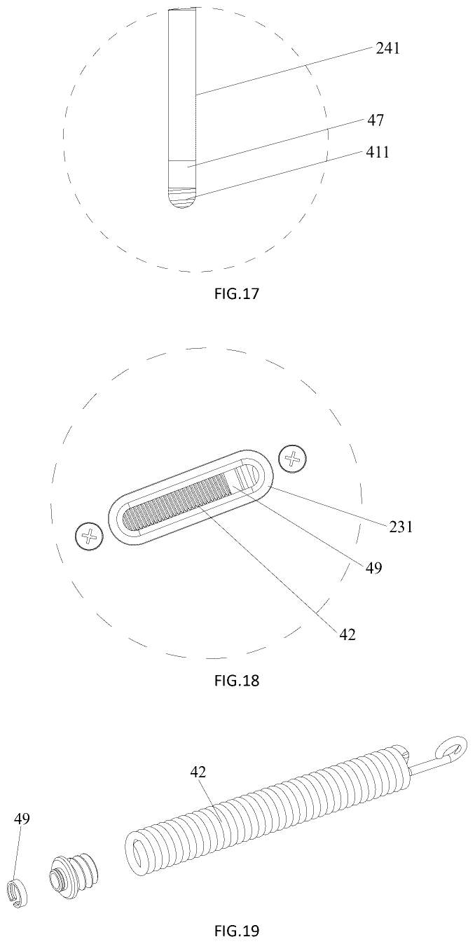

In some embodiments, as shown in FIGS. 1, 2 and 16, the height-adjustable mount further includes two front covers 24 disposed in or on the front side of the second frame assembly 20. Each front cover 24 is provided with a first window 241 at a position corresponding to the elastic member or assembly 41. As shown in FIGS. 1, 2, 10, 11, 16 and 17, the height adjustable mount further includes two stop assemblies 50 at a position corresponding to two first adjusting screws 45 for restricting rotation of the elastic member or assembly 41. Each stop assembly 50 is provided with a first indicator 47 at a position corresponding to the first window 241. The front cover 24 comprises a first scale 48 at a position proximate to the first window 241 in the direction of extension of the first window 241.

In this embodiment, the front cover 24 is disposed in or on the side of the second frame assembly 20 facing the first frame assembly 10 such that the outer surface of the second frame assembly 10 is obscured, which provides better protection for the internal structure of the height-adjustable mount and further enhances the aesthetics of the mount. It is easy to observe the elongation of the first adjusting screw 45 through the first window 241, then roughly estimate whether it matches the weight of the equipment to be lifted. The first adjusting screw 45 can be used to make the balance assembly 40 match the weight of the equipment to be lifted so that stable balance can be achieved.

The first scale 48 may be engraved on the periphery of the first window 241 employing silk-screen printing or laser printing, and the first scale 48 may show the actual weight value of the equipment to be lifted or have a certain correspondence with the actual weight of the equipment to be lifted. The weight of the equipment to be lifted can be estimated by the position of the first indicator 47 and its corresponding scale on the first window 241, which helps to identify whether the weight of the equipment to be lifted is over the rated weight capacity, and thus decide whether the first adjusting screw 45 need to be adjusted to make the elastic member or assembly 41 matches with the weight of the equipment to be lifted.

Specifically, the first indicator 47 may be disposed at a position of the stop connecting element 53 corresponding to the first window 241.

Further, as shown in FIG. 2, the edges of the front cover 24 are fixedly connected to the second frame 21 (the front cover 24 is not distanced from the first frame 11 in FIG. 2 to show the matching relationship between them). The edge of the front cover 24 near the frame center can be curved to avoid interfering with the middle connecting plate 12.

In some embodiments, as shown in FIGS. 3a and 3b, the height-adjustable mount further comprises a second connecting plate 23 that is positioned in front of the first frame assembly 10, and the edges of the second connecting plate 23 are fixedly connected to the second frame assembly 20. The second connecting plate 23 includes at least two guide wheels 232. The guide wheels 232 are disposed on two sides of the middle connecting plate 12, and the circumferential walls of the guide wheels 232 can be contacted with two sides of the middle connecting plate 12.

In this embodiment, the smoothness of the up and down movements of the height-adjustable mount can be improved by providing guide wheels 232 on the second connecting plate 23.

In addition, the second connecting plate 23 may also cover the first frame 11, so that the outer surface of the second frame assembly 20 is more completely obscured, improving the flatness of the appearance of the height-adjustable mount. In some examples, the front cover 24 and the second connecting plate 23 together cover the first frame 11, and it may be that the orthographic projection of the front cover 24 and the second connecting plate 23 do not overlap or have a partial overlap. In some instances, it is preferred that the orthographic projection of the front cover 24 and the second connecting plate 23 do not overlap, which saves material and facilitates thinning the thickness of the height-adjustable mount.

Further, the first connecting plate 22 is disposed on the side of the second frame 21 away from the second frame assembly 20, and the second connecting plate 23 is disposed on the side of the first frame 11 away from the second frame assembly 20. Thereby the balance assembly 40 and the rotating assembly 30 are arranged between the first connecting plate 22 and the second connecting plate 23, which helps reduce the thickness of the height-adjustable mount and hides and protects the internal structure, making the appearance of the height-adjustable mount looks more minimalist and generous.

More specifically, as shown in FIG. 2, the second connecting plate 23 attaches to the second frame assembly 20 using the left and right screws. The second connecting plate 23 is provided with an avoidance portion at a position corresponding to the middle connecting plate 12 for leaving space for the middle connecting plate 12. Thereby the surface keeps flat after assembling the middle connecting plate 12 and the second connecting plate 23. And the overall thickness of the height-adjustable mount is reduced. Moreover, when the middle connecting plate 12 drives the first frame 11 to move, the second connecting plate 23 can remain motionless, and the avoidance portion is disposed to eliminate the interference between the middle connecting plate 12 and the second connecting plate 23.

In some embodiments, as shown in FIGS. 1, 2, 16, 18 and 19, the second connecting plate 23 is provided with a second window 231 at a position corresponding to the first elastic member 42. The first elastic member 42 includes a second indicator 49 at a position corresponding to the second window 231, and the second connecting plate 23 is provided with a second scale at a position near the second window 231 along the extension direction of the second window 231.

In this embodiment, the second connecting plate 23 includes a second window 231 at a position corresponding to the first elastic member 42. It is easy to observe the elongation of the first elastic member 42 through the second window 231, and then roughly estimate whether it matches the weight of the equipment to be lifted, and whether it is necessary to perform adjustment, avoiding an unnecessary adjustment process.

The second scale may be engraved on the periphery of the second window 231 employing silk-screen printing or laser printing, and the second scale may show the actual weight value of the equipment to be lifted or have a certain correspondence with the actual weight of the equipment to be lifted. The weight of the equipment to be lifted can be estimated by the position of the second indicator 49 and its corresponding scale on the second window 231, which helps to identify whether the weight of the equipment to be lifted is over the rated weight capacity. It should be according to the actual situation to decide whether the second adjusting screws 46 need to be adjusted to make the first elastic member 42 match with the weight of the equipment to be lifted. Specifically, the second indicator 49 corresponding to the second window 231 may be disposed at an end of the second window 231 away from the second adjusting screw 46.

Reference numerals used in this present disclosure include: 10: First frame assembly; 11: First frame; 111: First sidewall; 112: Guide rail; 113: Stop portion; 12: Middle connecting plate; 121: First hinge joint; 122: Second hinge joint; 13: Mounting bracket; 20: Second frame assembly; 21: Second frame; 211: Second sidewall; 212: Side wheel; 213: Fitting section; 22: First connecting plate; 221: Second rotating shaft; 2211: Gear; 222: Assembly portion; 23: Second connecting plate; 231: Second window; 232: Guide wheel; 24: Front cover; 241: First window; 30: Rotation assembly; 31: First rotating member; 311: Protruding portion; 312: First rotating shaft; 313: Cam; 32: Second rotating member; 40: Balance assembly; 41: Elastic member or assembly ; 411: Third elastic member; 42: First elastic member; 421: Threaded sleeve; 43: Second elastic member; 44: Connecting member; 441: Connecting adaptor; 45: First adjusting screw; 46 Second adjusting screw; 47: First indicator; 48: First scale; 49: Second indicator; 50: Stop assembly; 51: First baffle; 52: Second baffle; 53: Stop connecting element; 531: Third sidewall; 5311: Pin hole; 532: Bottom wall; 54: Stop pin; 55: Sliding slot; L: First direction; W: Second direction; H: Third direction.

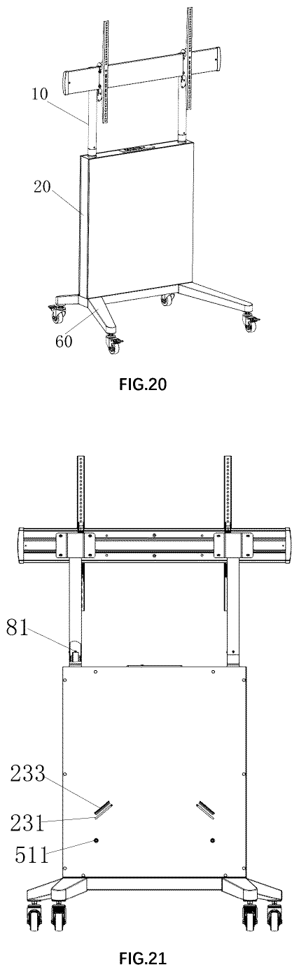

As shown in FIGS. 20-40, some embodiments of the present disclosure provide a support for a display device. The support for a display device comprises a second frame assembly 20 and a first frame assembly 10. The first frame assembly 10 is arranged to be liftable and lowerable relative to the second frame assembly 20. The first frame assembly 10 is used for supporting the display device. That is a displace device, such as a television or other can be coupled to the first frame assembly 10. The support also includes a balance assembly, which comprises a primary elastic mechanism, a rotation assembly 30 and an adjusting mechanism. One end of the rotation assembly 30 can be rotatably arranged on the second frame assembly 20, the other end of the rotation assembly 30 can be rotatably coupled to the first frame assembly 10. A first end of the primary elastic mechanism can be coupled to the second frame assembly 20 and a second end of the primary elastic mechanism acting on the rotation assembly 30. The primary elastic mechanism is configured for providing a balance force to the rotation assembly 30, so that the first frame assembly 10 can be kept in a balanced state at any position. The adjusting mechanism is configured for moving the second end of the primary elastic mechanism on the rotation assembly 30, so as to adapt to display devices of different weights. The primary elastic mechanism comprises at least one elastic member or assembly 41, and each elastic member or assembly 41 comprises at least one third elastic member 411.

For the illustrated embodiment, for example, after the display device is mounted on the first frame assembly 10, the weight of the display device acts on the rotation assembly 30 through the first frame assembly 10, and the elastic force of the primary elastic mechanism also acts on the rotation assembly 30. The moments and/or forces generated by the weight and the elastic force on the rotation assembly 30 are equal, balanced, or approximately equal, so that the rotation assembly 30 can be kept at any position relative to the second frame assembly 20, so that the first frame assembly 10 can be kept at any position relative to the second frame assembly 20, thereby achieving the hovering (constant height) of the display device. Thus, when the position of the display device in the vertical direction needs to be adjusted, the user can move the first frame assembly 10 to move the display device through the first frame assembly 10, so that the position of the display device can be adjusted. After the user removes the external force on the first frame assembly 10, the vertical position of the of the display device can be achieved again. In this way, the primary elastic mechanism is adopted to provide the balance force for the first frame assembly 10 for supporting the display device. In this way, a purely mechanical balance system is adopted so that the overheating protection problems commonly existing in the electric lifting systems can be avoided, and the shutdown waiting for cooling does not occur in frequent lifting operations, thereby meeting the frequent lifting requirements.

Further, compared with the traditional manual lifting systems, the support for a display device described herein can realize the lifting of the display device by directly moving the first frame assembly 10, thereby reducing the complexity of the operation and improving the user experience. Compared with traditional electric lifting systems, the support for a display device can realize the rapid and smooth lifting of the display device by directly moving the first frame assembly 10, thereby avoiding speed limitations of traditional electric lifting systems.

Further, support described herein includes an adjusting mechanism configured to finely adjust the action point of the second end of the primary elastic mechanism on the rotation assembly 30, thereby adapting to display devices of different weights. In this way, the support for a display device can provide stable support and the height free stop function for various display devices.

Further, the embodiments described herein employ a purely mechanical balance system based on the primary elastic mechanism and the rotation assembly 30, so that electronic components and the motor can be reduced or eliminated, thereby reducing production cost, and maintenance process can be simplified to reduce the long-term operation cost.

It should be noted that in the illustrated embodiment of the present disclosure, the first frame assembly 10 can maintain a balanced state at any position, which means that the display device on the first frame assembly 10 can remain at any position within the lifting range of the first frame assembly 10.

As shown in FIGS. 20-30, in some embodiments of the present disclosure, the support for the display device further comprises a guide member 15. The guide member 15 can be mounted in the second frame assembly 20. For example, the first frame assembly 10 can comprise a sliding member 102, the sliding member 102 can be in sliding fit with the guide member 15, the rotation assembly 30 being used for supporting the sliding member 102, part of the sliding member 102 extending out of the second frame assembly 20 and being used for supporting the display device.

With this arrangement, the display device is supported on the sliding member 102, the sliding member 102 extends out of the second frame assembly 20, and the guide member 15 is fixed inside the second frame assembly 20 to provide a sliding track for the sliding member 102. When it is necessary to adjust the height of the display device, the operator can manually apply a force on the sliding member 102 or the display device, and since the sliding member 102 is in sliding fit with the guide member 15, the applied force causes the sliding member 102 to slide along the guide member 15, thereby lifting the display device, and in the process of lifting the sliding member 102, the primary elastic mechanism supports the sliding member 102 through the rotation assembly 30 to balance the weight of the display device, so that the display device maintains a balanced state at any position. In this way, the sliding fit between the sliding member 102 and the guide member 15, and the supporting and balancing capabilities of the primary elastic mechanism and the rotation assembly 30 enable the support to be frequently lifted and lowered to meet the needs of users of different heights.

As shown in the illustrated embodiment of FIGS. 24, 28 and 29, the guide member 15 is a guide rod, and the sliding member 102 is a sleeve, the first end of the sleeve being in sliding fit with the guide rod, and the second end of the sleeve extending out of the second frame assembly 20 and being used for supporting the display device. In this way, the sliding fit between the guide member 15 and the sliding member 102 can be achieved.

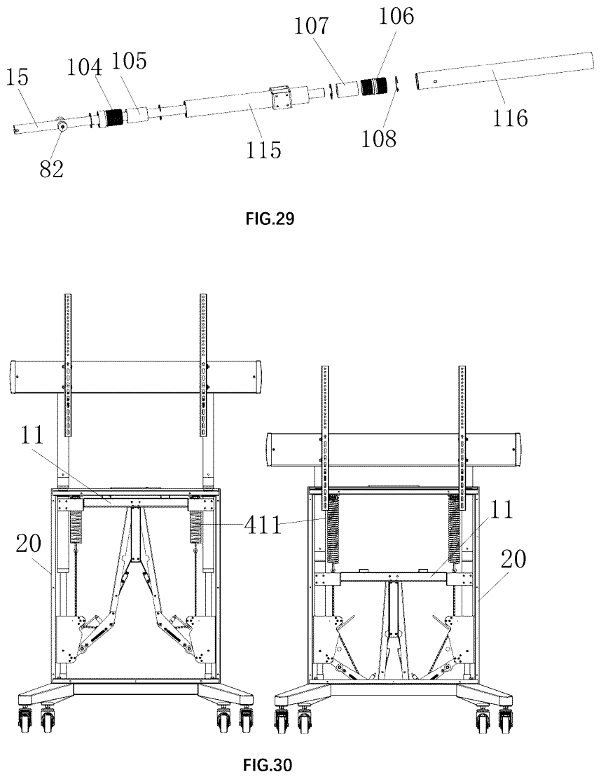

As shown in FIG. 29, the support for a display device further comprises a first mounting sleeve 104 and a first sliding sleeve 105, the first mounting sleeve 104 being coupled with the first end of the sleeve, and the first sliding sleeve 105 being mounted between the first mounting sleeve 104 and the guide rod 15. In this way, the sleeve and the guide rod 15 can slide more smoothly.

In some preferred embodiments, the first sliding sleeve 105 is a linear bearing.

As shown in FIG. 24 and FIG. 29, the sleeve comprises a main cylindrical section 115 and an extended cylindrical section 116, the main cylindrical section 115 is located in the second frame assembly 20 and is in sliding fit with the guide rod 15, at least part of the extended cylindrical section 116 extends out of the second frame assembly 20, the support for the display device further comprises a second mounting sleeve 106 and a second sliding sleeve 107. In the illustrated embodiment, two ends of the second mounting sleeve 106 are coupled with the main cylindrical section 115 and the extended cylindrical section 116 respectively, and the second sliding sleeve 107 is mounted between the second mounting sleeve 106 and the guide rod.

Through this arrangement, the sleeve can be extended so that the sleeve can extend out of the second frame assembly 20 to support the display device, and the second sliding sleeve 107 can further make the sliding between the sleeve and the guide rod smoother.

In some preferred embodiments, the second sliding sleeve 107 is a linear bearing.

In the illustrated embodiment as shown in FIG. 29, two linear bearings are mounted on the first mounting sleeve 104 and the second mounting sleeve 106 respectively, and each linear bearing is blocked at the front and the back by an inner retaining ring 108. One end of the first mounting sleeve 104 is provided with a thread, which can be in threaded fit with the main cylindrical section 115, so that the bearing is mounted on one end of the main cylindrical section 115, and both ends of the second mounting sleeve 106 are provided with threads, one end of the second mounting sleeve 106 is coupled with the main cylindrical section 115, and the other end of the second mounting sleeve 106 is coupled with the extended cylindrical section 116.

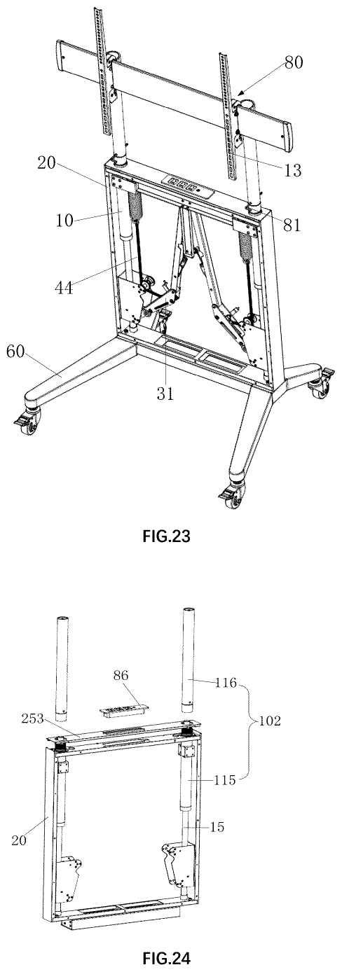

As shown in FIG. 23, the support for the display device further comprises a hanging arm assembly 80 and a limiting member 81, the hanging arm assembly 80 is mounted on the sleeve and is located outside the second frame assembly 20, and the limiting member 81 is detachably mounted on the sleeve and is located between the second frame assembly 20 and the hanging arm assembly 80, and the limiting member 81 is used for limiting the movement of the sleeve.

Through the above arrangement, when the display device is mounted on the hanging arm assembly 80, the limiting member 81 can be mounted on the sleeve, so that even if the elastic force provided by the primary elastic mechanism to the rotation assembly 30 is insufficient to support the first frame assembly 10, the first frame assembly 10 will not descend due to the weight of the display device under the action of the limiting member 81, thereby facilitating the mounting of the display device and the adjustment of the position of the second end of the primary elastic mechanism on the rotation assembly 30 by the adjusting mechanism to adapt to the weight of the current display device; when the display device can be in a balanced state, the limiting member 81 can be detached from the sleeve to facilitate the adjustment of the height of the display device.

In some embodiments, a through hole can be provided on the sleeve, and the limiting member 81 is a wrench penetrating through the through hole.

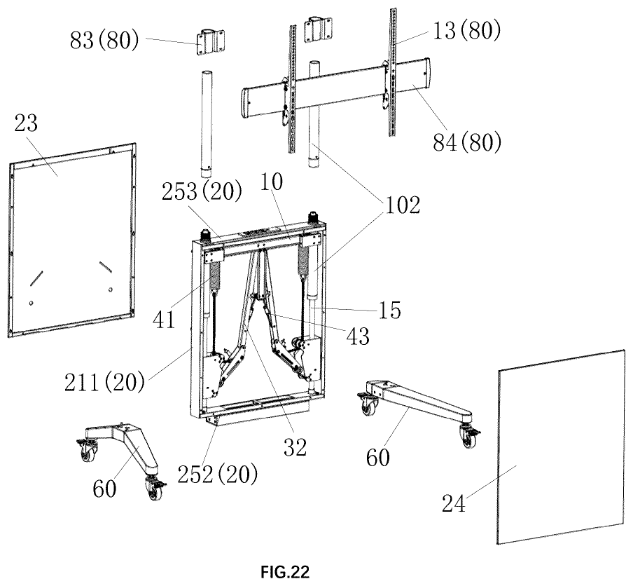

In some embodiments, for example, as shown in FIG. 22, the hanging arm assembly 80 comprises a crossbar connecting plate 83, a crossbar 84 and a hanging arm 13, the hanging arm 13 is mounted on the crossbar 84 after the display device is mounted, the crossbar connecting plate 83 is mounted on the extended cylindrical section 116, and the crossbar connecting plate 83 is coupled with the crossbar 84, so that the crossbar 84 is coupled with the extended cylindrical section 116, and this mounting mode can reduce the packaging volume.

As shown in FIG. 29, in this illustrated embodiment, the support for display device further comprises a limiting element 82. For example, the guide member 15 is provided with the limiting element 82 to limit the sliding range of the sliding member 102.

In this example, the limiting element 82 is arranged to ensure that the display device does not exceed the safe range when the height is adjusted, thereby preventing the risk of structural damage or display device falling caused by excessive lifting.

In some embodiments, the guide member 15 is fixedly mounted on the second frame assembly 20.

As shown in the illustrated embodiment of FIGS. 22 to 25, the guide member 15 is two, the sliding member 102 is two, the two sliding members 102 are respectively in sliding fit with the two guide members 15, the first frame assembly 10 further comprises a first frame 11, the first frame 11 is located in the second frame assembly 20, the two sliding members 102 are coupled to two ends of the first frame 11, and the top end of the rotation assembly 30 is in rotary connection with the first frame 11.

In this example, the configuration of the two guide members 15 and the two sliding members 102 significantly enhances the stability of the overall structure compared with the design of a single guide member and a single sliding member. The double-side support structural design makes the display device more stable when being lifted and lowered, thereby reducing the risk of shaking and tilting, especially when bearing a heavy load. The two sliding members 102 are coupled by the first frame 11, which not only disperses the weight of the display device and improves the bearing capacity, but also ensures that the support maintains good structural stability and smooth movement even when bearing a heavy display device.

In some embodiments, the first frame 11 is coupled with the main cylindrical section 115. The first frame 11 is a connecting plate.

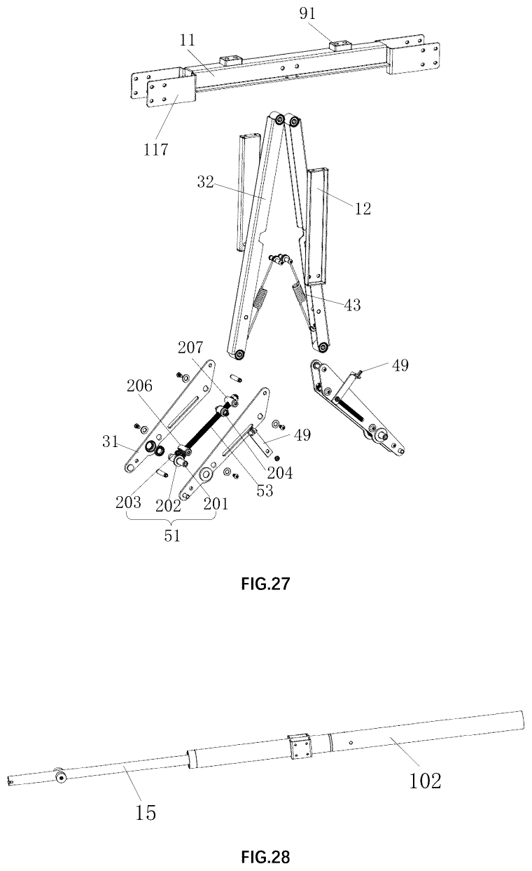

In some embodiments, for example, as shown in FIG. 27, the top of the first frame 11 is provided with a limiting pad block 91, and when the first frame 11 is raised to the highest position, the limiting pad block 91 is in contact with the upper cover plate 253.

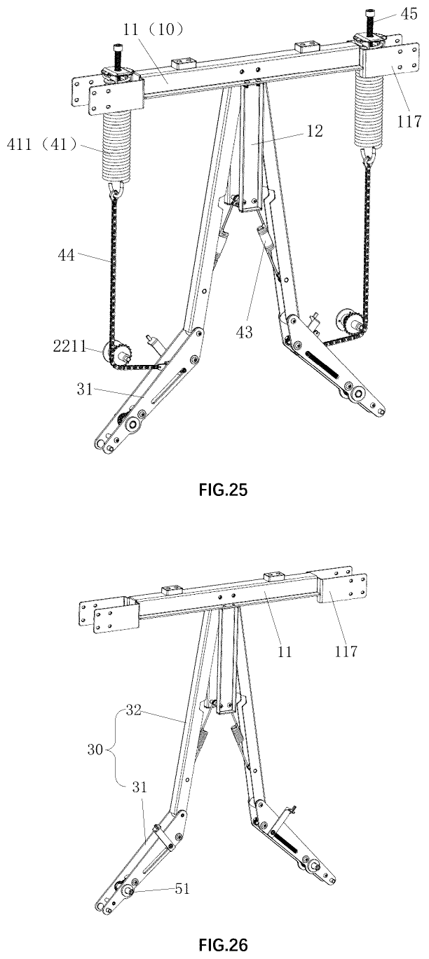

As shown in FIGS. 25 and 27, the adjusting mechanism can include: an operating member 51; a moving member 204; and an adjusting member 53 arranged on the rotation assembly 30, wherein the moving member 204 is located between two ends of the adjusting member 53, the second end of the primary elastic mechanism is coupled with the moving member 204, and the moving member 204 moves on the adjusting member 53 by operating the operating member. The adjusting member 53 may be, for example, a screw.

In some embodiments, the operating member is operated to move the moving member 204 on the adjusting member 53, so that the moving member 204 drives the second end of the primary elastic mechanism to move, so as to stretch or shorten the elastic member or assembly 41 and change the position of a connection point of the elastic member or assembly 41 to the first rotating member 31 on the first rotating member 31 such that a force arm length between a rotational connection point of the first rotating member 31 to the second frame assembly 20 and the connection point of the first rotating member 31 to the elastic member or assembly 41 is changed, thereby increasing or reducing the torque generated by the elastic force on the rotation assembly 30, so as to adjust the pre-tightening force of the primary elastic mechanism, and the support for display device can balance the installation of display devices with different weights.

As shown in FIG. 27, the adjusting member 53 is rotatably arranged in the rotation assembly 30, the moving member 204 is located at the outer periphery of the adjusting member 53 and threadedly engages with the adjusting member 53, the moving member 204 slidingly engages with the rotation assembly 30, and the operating member is used to drive the adjusting member 53 to rotate. For example, the operating member can be a screwdriver which can engage with the end of the adjusting member and drive the adjusting member 53 to rotate.

In some embodiments, the user only needs to rotate the adjusting member 53 through the operating member to realize the movement of the moving member 204 to adjust the height of the display device, which is easy to use; and through the thread engagement between the moving member 204 and the adjusting member 53, a slight displacement change can be realized, which enables the user to accurately adjust the height of the display device to adapt to different use scenarios and user needs.

Further, the moving member 204 slidingly engages with the rotation assembly 30, ensuring the smoothness and low friction of movement during the adjustment, so that the display device has a smoother experience during the lifting and lowering process and does not appear to be stuck or resistant.

In some embodiments, the adjusting member 53 is a screw or threaded rod.

As shown in FIG. 27, the operating member 51 can include: an operation element 201; a first gear 202 coupled to the outer periphery of the operation element 201; and a second gear 203 coupled to one end of the adjusting member 53, wherein the first gear 202 and the second gear 203 are meshingly arranged, the axis of the operation element 201 and the axis of the adjusting member 53 are arranged at an angle, and at least one end of the operation element 201 is exposed to the rotation assembly 30 and the second frame assembly 20.

In some embodiments, the axis of the operation element 201 and the axis of the adjusting member 53 are arranged at an angle, and the first gear 202 and the second gear 203 are meshingly arranged, so that the rotation force of the operation element 201 can be transmitted to the adjusting member 53 through the first gear 202 and the second gear 203, the operating member can be installed in a limited space, the space utilization of the overall structure is optimized, and meanwhile, the interference of the operation element 201 with other structures is avoided, and the smooth operation is ensured.

Further, at least one end of the operation element 201 is exposed to the rotation assembly 30 and the second frame assembly 20, so that the operator can directly operate the operation element 201 without disassembling or moving other components, and the convenience and efficiency of operation are improved.

In some examples, one end of the operation element 201 is exposed to the rotation assembly 30 and the second frame assembly 20, which means that the one end of the operation element 201 can be in the rotation assembly 30, the rotation assembly 30 and the second frame assembly 20 are both provided with through holes, and the two through holes are both correspondingly arranged with the one end of the operation element 201, so that a wrench can be inserted into the two through holes to adjust the operation element 201; or the one end of the operation element 201 can also protrude out of the rotation assembly 30 and the second frame assembly 20 for convenient adjustment.

In some examples, the first gear 202 and the second gear 203 are both bevel gears.

As shown in FIGS. 25 and 26, the rotation assembly 30 includes: a second rotating member 32, one end of which is rotationally coupled with the first frame assembly 10; a first rotating member 31, one end of which is rotationally coupled with the second rotating member 32, and the other end of which is rotationally coupled with the second frame assembly 20, and a primary elastic mechanism acting between the two ends of the first rotating member 31.

In some embodiments, the primary elastic mechanism acts between the two ends of the first rotating member 31, and the elastic force of the primary elastic mechanism generates a moment or force on the first rotating member 31 and supports the display device through the second rotating member 32 and the first frame assembly 10, so that the display device can be suspended. It should be noted that in this embodiment, the second rotating member 32 is a rigid support rod, and the support rod is rotationally coupled to the first frame 11. The first frame 11 is coupled the sliding member 102 through the U-shaped piece 117 at the two ends of the first frame 11.

As shown in FIG. 27, the first rotating member 31 comprises two rotating plates, and the rotation assembly 30 further comprises a first connecting shaft 206 and a second connecting shaft 207, one end of each of the two rotating plates is hinged with the second frame assembly 20, the other end of each of the two rotating plates is hinged with the second rotating member 32, the first connecting shaft 206 and the second connecting shaft 207 are installed between the two rotating plates and used for connecting the two rotating plates, the adjusting member is rotationally penetrated through the first connecting shaft 206 and the second connecting shaft 207, the end of the adjusting member 53 is limited by a nut, and the head of the adjusting member 53 is provided with an operating member 51. Therein, the two ends of the moving member 204 are provided with limiting shafts, the two rotating plates are correspondingly provided with sliding grooves, and the two limiting shafts are respectively slidably matched with the two sliding grooves.

As shown in FIGS. 22-27, the two balance assemblies are arranged in a mirror-symmetrical manner.

In some embodiments, the two balance assemblies are symmetrically distributed, can evenly disperse the weight of the display device, ensure the stability of the structure during lifting and while stationary, and avoid the inclination or shaking phenomenon possibly caused by unilateral force. In some instances, when compared with a single balance assembly, the configuration of the two balance assemblies significantly improves the bearing range of the system, allows the support to carry a heavier display device, and does not affect the stability of lifting and the stability of the structure.

As shown in FIGS. 25-27, the balance assembly comprises an auxiliary elastic mechanism, which comprises a second elastic member 43. The first frame assembly 10 comprises a middle connecting plate 12, the top of the middle connecting plate 12 being coupled to the first frame 11. One end of the second elastic member 43 is rotationally coupled to the middle connecting plate 12, and the other end of the second elastic member 43 is rotationally coupled with the second rotating member 32, and the primary elastic mechanism and the auxiliary elastic mechanism are respectively located on the two sides of the rotation assembly 30.

In some embodiments, the auxiliary elastic mechanism can work with the primary elastic mechanism and compensate for the deficiency of the primary elastic mechanism in some positions, so that the weight of the display device at different heights can be more stably balanced (that is, the whole process is actually the combined action of the primary elastic mechanism and the auxiliary elastic mechanism to balance the weight), the stability during lifting and lowering is ensured, the free stop function is realized, the shaking or jamming during lifting and lowering is reduced, the operation is smoother, and the user experience is improved.

Further, the auxiliary elastic mechanism and the primary elastic mechanism are respectively located on two sides of the rotation assembly 30, a symmetrical and balanced structure is formed, the stability of the overall structure is enhanced, and it is ensured that the bracket does not deviate or shake during lifting and lowering.

In some embodiments, the middle connecting plate 12 is a plate structure, and the second elastic member 43 is a spring.

As shown in FIG. 21 and FIG. 27, the adjusting mechanism further comprises a second indicator 49, the second frame assembly 20 is provided with a graduated scale 233, the moving member 204 is provided with the second indicator 49, the second frame assembly 20 is provided with a second window 231, the graduated scale 233 is located on one side of the second window 231, and at least part of the second indicator 49 is shown through the second window 231.

In some embodiments, the second indicator 49 is coupled with the moving member 204, and the second window 231 can show the position of the second indicator 49 on the graduated scale 233, thereby providing an intuitive weight adjustment indication for the user, so that the user can easily adjust the elasticity of the primary elastic mechanism by referring to the position of the second indicator 49 on the graduated scale 233, thereby accurately adapting to display devices of different weights, the visual adjustment mechanism significantly improves the weight adjustment efficiency, the user can directly observe the real-time effect of the elasticity adjustment, the tedious process of repeatedly lifting and lowering the display device to find the correct weight setting is avoided, and the weight adjustment becomes more rapid and simple.

It should be noted that, in the illustrated embodiment of the present disclosure, at least part of the second indicator 49 is shown through the second window 231, which means that at least part of the second indicator 49 can extend out of the second window 231, or can be located in the second window 231, as long as the user can see the second indicator 49 through the second window 231.

In some examples, the second indicator 49 is an indication strip, and the indication strip has a more eye-catching color, for example, red.

As shown in FIG. 25, the primary elastic mechanism can include: an elastic member or assembly 41 coupled with the second frame assembly 20; a guiding member 2211 rotatably arranged on the second frame assembly 20; and a connecting member 44, one end of the connecting member 44 being coupled with the elastic member or assembly 41, and the other end of the connecting member 44 being rotatably coupled with the rotation assembly 30 after being wound around the guiding member 2211.

In some embodiments, the elastic member or assembly 41 is coupled with the second frame assembly 20 to stably provide the elastic force, the connecting member 44, as a force transmission medium, is coupled with the elastic member or assembly 41 at one end and is wound around the guiding member 2211 and coupled with the rotation assembly 30 at the other end, so that the elastic force can be accurately transmitted to the rotation assembly 30 to achieve balanced force adjustment, and the rotatable guiding member 2211 reduces friction and resistance of the connecting member 44 during force transmission, ensures smoothness and no jamming during lifting and lowering of the display device, and enables the user to easily move the display device up and down without applying additional force to overcome friction, thereby improving the smoothness and efficiency of the lifting and lowering operation.

In some examples, the elastic member or assembly 41 is a spring, the connecting member 44 is a chain, and the guiding member 2211 is a chain wheel.

As shown in FIG. 22, the second frame assembly 20 comprises a support frame including two side plates 211, an upper cover plate 253 and a lower cover plate 252, the two side plates 211 being respectively used for coupling the upper cover plate 253 and the lower cover plate 252, a front cover 24 and a rear cover plate 23 being respectively coupled to front and rear sides of the support frame to enclose an installation cavity for accommodating the balance assembly.

In some embodiments, the connection of the side plates 211, the upper cover plate 253 and the lower cover plate 252 forms a firm support frame, provides a stable structural basis for the whole display device support, enhances the bearing capacity and mechanical strength, and ensures the stability and safety when supporting heavy objects; and the front cover 24 and the rear cover plate 23 enclose the balance assembly and other internal mechanical structures in an installation cavity, effectively protect these components from external environmental factors (such as dust and moisture), and also hide the internal complex mechanical structures, thereby improving the tidiness and aesthetics of the device.

Specifically, as shown in FIG. 24, the upper cover plate 253 can be mounted with an embedded power supply 86 and internally routed, so that the power supply line of the display device can be hidden, making it more concise.

As shown in FIGS. 20 and 22, the support for the display device further comprises a support leg 60, the second frame assembly 20 is arranged on the support leg 60, and a plurality of rolling members are arranged on a side of the support leg 60 away from the second frame assembly 20.

In some embodiments, the rolling members are arranged to enhance the mobility of the support, and the user can easily move the display device between different positions without additional moving tools or manpower.

It should be noted that the support for the display device provided by the embodiments of the present disclosure has the advantages of high free stopping, frequent lifting and lowering at will, large bearing range, good lifting and lowering experience, and convenient force value adjustment.

In some embodiments, the support leg 60 is two legs, and the two support legs 60 are left and right support legs respectively.

It should be noted that when an external force is applied to the extended cylindrical section 116, the extended cylindrical section 116 is lifted or lowered to drive the first frame 11 to be lifted or lowered, so that the rotation assembly 30 is rotated, and then the elastic member or assembly 41 is stretched by the connecting member 44 to generate a spring force to balance the externally applied external force.

The support for display device of the above embodiments of the present disclosure meets the free stop of a certain bearing range, and the process of adjusting the bearing capacity is as follows: the first gear 202 can be rotated to drive the adjusting member to rotate, so that the moving member 204 is moved, and one end of the connecting member 44 is coupled to the moving member 204, so that the elastic member or assembly 41 can be stretched on one hand, and the initial stretching force of the elastic member or assembly 41 is changed, and on the other hand, the action point of the elastic member or assembly 41 on the rotation assembly 30 is changed, so as to adapt to displays with different weights. The rear cover plate 23 is provided with a through hole for adjusting the first gear 202 and a groove in which an indicating strip can be seen, and the groove is printed with a scale. Since the rotating plate is at different angles at different heights, the through hole of the first gear 202 and the groove of the indicating strip on the rear cover plate 23 can be corresponded at the highest position, so that a limiting part (that is, the limiting member 81) is required at the highest position. In this embodiment, a through hole is formed in the extended cylindrical section 116 of the sliding member 102, and the limiting member 81 (a wrench or a screwdriver) is passed through the through hole and abuts against the upper surface of the guide member 15, so that the sliding member 102 cannot be lifted or lowered. At this time, the force value is adjusted again, the indicating strip is adjusted to the same scale as the weight of the display device, and finally, the wrench or the screwdriver is removed, and then the spring force can be completely relied on to balance the gravity of the display device.

It should be noted that in some embodiments of the present disclosure, the balance of the weight of the elastic member or assembly 41 and the display device is achieved, and the weight acts on the first rotating member 31 through the first frame 11 and the second rotating member 32. The weight is constant, but the angle of the weight acting on the first rotating member 31 through the second rotating member 32 is changed, that is, the torque of the weight rotating the first rotating member 31 is always changed.

It should be noted that in some embodiments of the present disclosure, the elastic force is applied to the first rotating member 31 by the connecting member 44, the elastic force of the elastic member 41 is always changing, the angle of the elastic force and the first rotating member 31 is also always changing, that is, the torque of the elastic force for rotating the rotating member is also always changing. In order to enable the display device to stop freely, it is necessary to ensure that the torque of the weight is always equal to the torque of the elastic force at each position. By listing the formulas and inputting them into a computer simulation, the parameters of the elastic member 41 and the second elastic member 43, and the position of the connection points of the elastic force and the weight on the first rotating member 31, and other important parameters can be obtained.

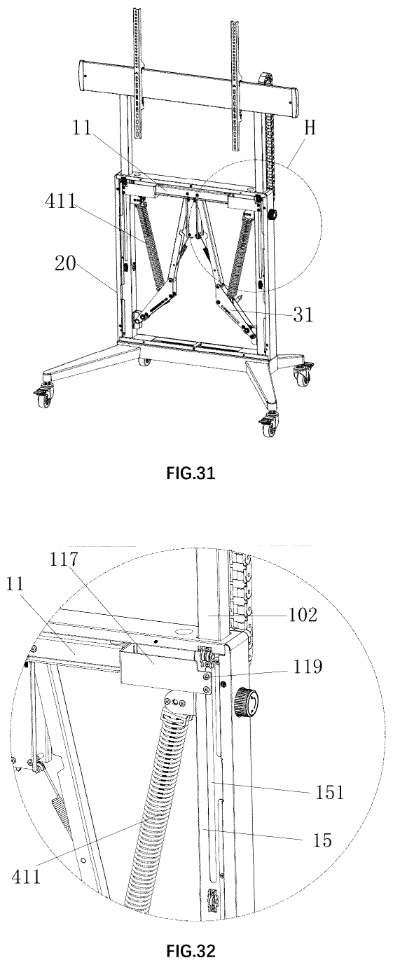

As shown in FIGS. 31 and 32, another embodiment of the present disclosure provides another support for a display device. In this embodiment, the bottom end of the elastic member or assembly 41 of the primary elastic mechanism is directly coupled to the first rotating member 31. Preferably, the bottom end of the elastic member or assembly 41 is directly coupled to the moving member 204 on the first rotating member 31. The guide member 15 is a cylindrical structure, and the sliding member 102 is sleeved in the guide member 15. In this embodiment, the guide member 15 is a square tube, and the guide member 15 is provided with an elongated slot 151 extending upward and downward; the U-shaped members at both ends of the first frame 11 are fixedly coupled to the sliding member 102 by bolts 119, and the bolts 119 pass through the elongated slot 151 to fixedly couple the U-shaped members 117 outside the guide member 15 to the sliding member 102 inside the guide member 15.

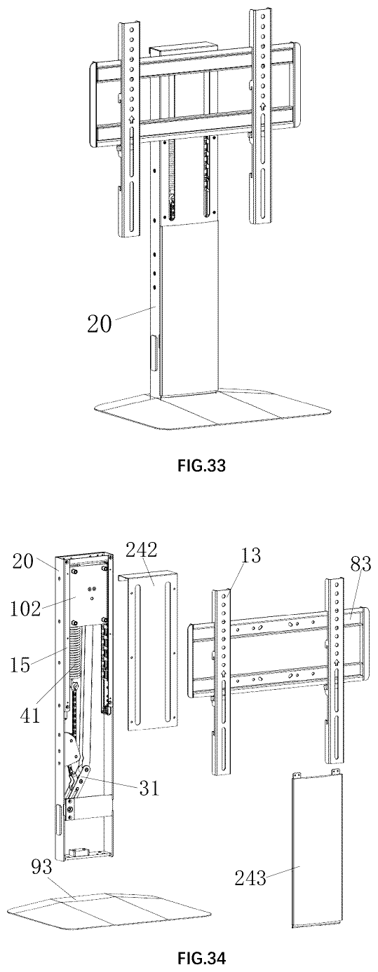

As shown in FIGS. 33 to 40, in some embodiments of the present disclosure, the guide member 15 includes two spaced apart sliding rails, and the sliding member 102 is a sliding plate. In this way, the sliding cooperation between the guide member 15 and the sliding member 102 can be achieved.

As shown in FIG. 38, the second frame assembly 20 is provided with a limiting element 82, and the limiting element 82 is located below the rotation assembly 30 to limit the rotation range of the rotation assembly 30.

In some embodiments, the maximum angle of rotation of the rotation assembly 30 is limited by the limiting element 82, so that the display device can be prevented from exceeding the safe range during height adjustment, thereby preventing the risk of structural damage or display device falling caused by excessive lifting.

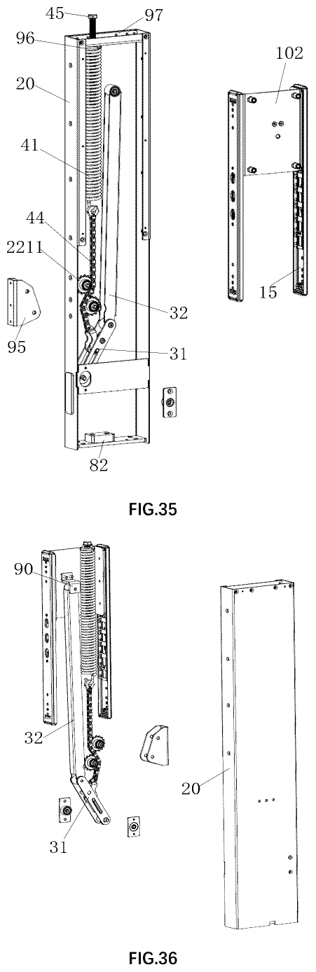

In some embodiments, for example, as shown in FIG. 35, the guide member 15 is one, the sliding member 102 is one, and the rotation assembly 30 is in rotational cooperation with the sliding member 102. By simplifying the guide member 15 and the sliding member 102 into a single component, the number of parts is reduced, thereby simplifying the overall structure and reducing the complexity of assembly and maintenance; and the single guide member 15 and sliding member 102 can also reduce mechanical failure points and improve the reliability and durability of the system.

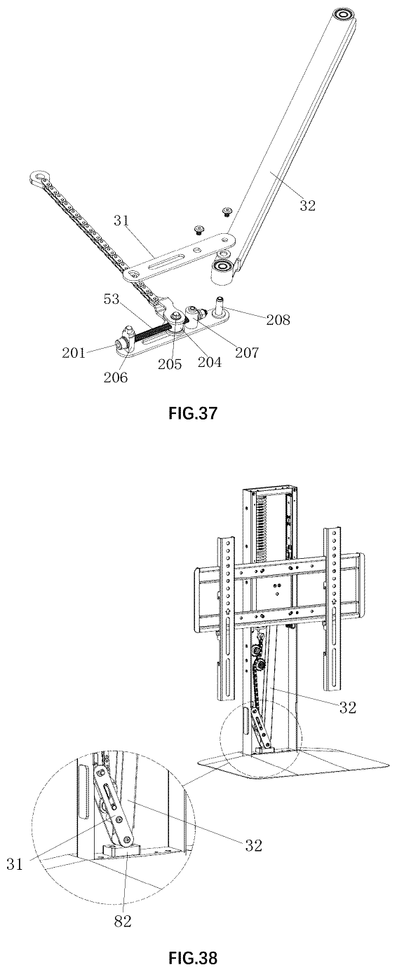

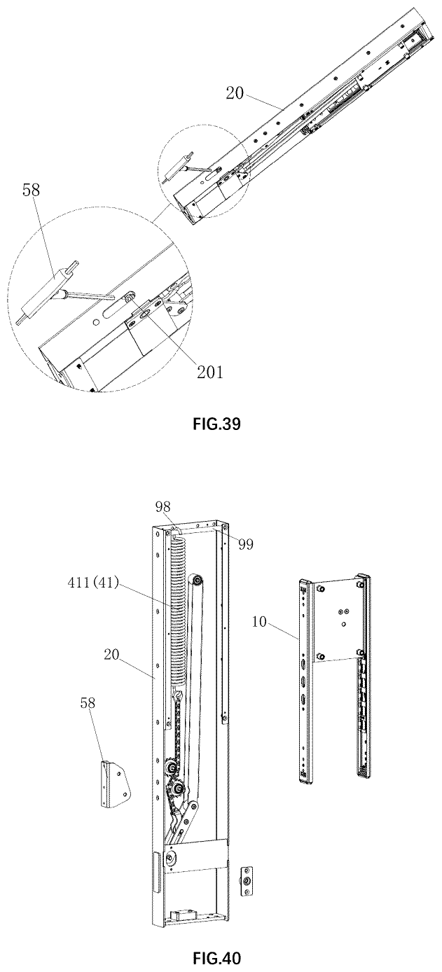

As shown in FIGS. 37 and 39, the operating member only includes the operation element 201, the operation element 201 is coupled to one end of the adjusting member 53, and at least part of the operation element 201 is exposed to the rotation assembly 30 and the second frame assembly 20. By exposing the operation element 201 to the rotation assembly 30 and the second frame assembly 20, the wrench 58 can be rotated to the operation element 201, so that the adjusting member 53 can be rotated by the operation element 201.

It should be noted that the at least part of the operation element 201 exposed to the rotation assembly 30 and the second frame assembly 20 means that the at least part of the operation element 201 can be in the rotation assembly 30, the rotation assembly 30 and the second frame assembly 20 are provided with through holes, and the two through holes are provided with the at least part of the operation element 201, so that a wrench can be inserted into the two through holes to adjust the operation element 201; the at least part of the operation element 201 can also be stretched out of the rotation assembly 30 and the second frame assembly 20 for adjustment.

As shown in FIG. 35, the support for display device further comprises an first adjusting screw 45 rotatably arranged on the second frame assembly 20, and the elastic member or assembly 41 is provided with a spring sleeve 96, and the first adjusting screw 45 is in threaded cooperation with the spring sleeve 96, that is, the first adjusting screw 45 is rotated to stretch the elastic member or assembly 41 (the elastic member or assembly 41 can be a mechanical spring or an air spring, and if the elastic member or assembly 41 is the air spring, the first adjusting screw 45 is not required to be arranged, and one end of the air spring is directly mounted on the second frame assembly 20. In this embodiment, the elastic member or assembly 41 is a mechanical spring, one end of a connecting member 44 is coupled to the elastic member or assembly 41, and the other end of the connecting member 44 is hinged to two rotating plates in the first rotating member 31 through a guiding member 2211. In this way, the first adjusting screw 45 is rotated to stretch the elastic member or assembly 41, and only the initial stretching amount needs to be set, and subsequent change of the bearing capacity does not require the first adjusting screw 45 to be rotated to adjust the spring force.

As shown in FIG. 35, the balance assembly is one. In this way, the number of components can be reduced, thereby simplifying the overall structure and reducing the complexity of assembly and maintenance. The second frame assembly 20 is provided with a connecting plate 97, the first adjusting screw 45 passes through the connecting plate 97 and is in threaded cooperation with the spring sleeve 96 on the elastic member or assembly 41, so that rotating the first adjusting screw 45 can stretch the elastic member or assembly 41 to change the preset initial spring force (here, stretching the elastic member or assembly 41 is not used to adjust the adaptation to televisions with different bearing weights, but is only the initial preset spring force).

As shown in FIG. 40, in some embodiments, the spring sleeve 96 and the connecting plate 97 can be eliminated, and a connecting shaft 99 is used instead, and the connecting shaft 99 is mounted on the second frame assembly 20. The elastic member or assembly 41 is provided with a hook 98, and during installation, the hook 98 of the elastic member or assembly 41 is stretched to the connecting shaft 99 by a tool, and is hung thereon, so that the spring sleeve 96 and the screw can be reduced, and the cost can be reduced.

As shown in FIG. 35, in some embodiments of the present disclosure, the sprocket is mounted on the second frame assembly 20 through a sprocket frame 95, and the sprocket can move in a circle.

As shown in FIG. 37, in some embodiments of the present disclosure, the rotation assembly 30 further comprises a third connecting shaft 208, one end of the two rotating plates is hinged to the second rotating member 32 through the third connecting shaft 208, the other end of the two rotating plates is hinged to the second frame assembly 20 through the first connecting shaft 206, the second connecting shaft 207 is mounted between the two rotating plates, the first connecting shaft 206, the second connecting shaft 207 and the third connecting shaft 208 are used for connecting the two rotating plates, the adjusting member 53 is rotatably provided on the first connecting shaft 206 and the second connecting shaft 207, the end of the adjusting member 53 is positioned by a nut, the head of the adjusting member 53 is provided with an operating member 201, the operating member 201 is provided with an inner hexagonal hole, the two ends of the moving member 204 are provided with limiting shafts 205, the two rotating plates are correspondingly provided with sliding grooves, the two limiting shafts are in sliding cooperation with the two sliding grooves, the second frame assembly 20 is provided with a hole, and an inner hexagonal wrench can rotate the adjusting member 53 through the hole to change the position of the chain rope on the rotation assembly 30, thereby adapting to televisions with different weights.

As shown in FIG. 34, in some embodiments of the present disclosure, the support for display device further comprises a base 93 and a panel trim strip 94, and the second frame assembly 20 is arranged on the base 93, wherein the front cover 24 of the second frame assembly 20 comprises an upper half cover 242 and a lower half cover 243 for covering the internal structure of the second frame assembly 20, the hanging arm 13 is hung on the crossbar connecting plate 83 after the television is mounted, the crossbar connecting plate 83 is fixed on the sliding member 102, and the panel trim strip is used for covering the bolt for fixing the crossbar connecting plate 83.

In some embodiments, the auxiliary elastic mechanism can also be omitted.

It should be noted that the embodiment shown in FIGS. 33-40 of the present disclosure provides a support for display device which can be freely lifted and lowered in height, has the advantages of high free stop, large bearing range, good lifting experience, and convenient force value adjustment.

It should be noted that the support for display device shown in FIGS. 33-40 of the present disclosure can also satisfy different weight televisions. For example, when the weight of the television is small, the adjusting member 53 is rotated to make the moving member 204 close to the first connecting shaft 206, and then the elastic force acts on the rotation assembly 30 through the chain rope, so that the torque of the rotation assembly 30 is reduced, thereby adapting to the weight of the small bearing television. When the weight of the television is relatively large, the adjusting member 53 is rotated to make the moving member 204 away from the first connecting shaft 206, and then the elastic force acts on the rotation assembly 30 through the chain rope, so that the torque of the rotation assembly 30 is increased, thereby adapting to the weight of the large bearing television.

From the above description, it can be seen that the embodiments of the present disclosure achieve one or more of the following technical effects: after the display device is mounted on the support assembly, the gravity of the display device acts on the rotation assembly through the support assembly, and the elastic force of the primary elastic mechanism acts on the rotation assembly, and the torque generated by the gravity and the elastic force on the rotation assembly is equal, so that the rotation assembly can be kept at any position relative to the base frame, so that the support assembly can be kept at any position relative to the base frame, thereby the hovering of the display device can be realized, so that when the position of the display device in the vertical direction needs to be adjusted, the user can move the support assembly to drive the display device to move through the support assembly, so that the position of the display device can be adjusted, and after the user removes the external force on the support assembly, the hovering of the display device can be realized again, so that the primary elastic mechanism is adopted to provide a balance force for the support assembly for supporting the display device, that is, the mechanical balance system is adopted, so that the overheating protection problem common in the electric system can be avoided, and the shutdown waiting for cooling does not occur in the frequent lifting operation, so that the frequent lifting demand can be met.

It is to be noted that, in this document, relational terms such as first and second are used only to distinguish one entity or operation from another, and do not necessarily require or imply any such actual relationship or order between those entities or operations. Furthermore, the terms “including”, “comprising”, or any other variant thereof, are intended to cover non-exclusive inclusion, such that a process, method, article, or apparatus comprising a set of elements includes not only those elements, but also other elements not expressly listed, or also includes elements that are inherent to such process, method, article or apparatus. Without further limitation, the fact that an element is defined by the phrase “includes a . . . ” does not preclude the existence of additional identical elements in the process, method, article, or apparatus.

The various embodiments in this specification are described in a related manner, and it is sufficient to refer to each embodiment for the same and similar parts of each embodiment, and each embodiment focuses on the differences from the other embodiments.

The foregoing detailed description has been given for understanding exemplary embodiments of the invention and no unnecessary limitations of the claims should be understood. Any modifications, equivalent substitutions, or improvements made within the spirit and principles of the present disclosure are included in the scope of protection of the present disclosure.

What is claimed is:

1. A height-adjustable mount for supporting a display, comprising:
a first frame assembly, a second frame assembly, a rotating assembly, and a balance assembly, wherein:
the first frame assembly is coupled to and slidable along the second frame assembly;
the rotation assembly comprises a first rotating member and a second rotating member, wherein:
a first end of the first rotating member rotationally couples with the second frame assembly,
a second end of the first rotating member rotationally couples with a first end of the second rotating member, and
a second end of the second rotating member rotationally couples with the first frame assembly; and
the balance assembly comprises an elastic member or assembly, wherein a first end of the elastic member or assembly is coupled to the second frame assembly, a second end of the elastic member or assembly is coupled to the first rotating member, and the elastic member or assembly is provides a balancing force to the rotating assembly such that the first frame assembly can keep a balanced state at any position.

2. The height-adjustable mount according to claim 1, wherein a connection point of a lower end of the elastic member or assembly and the first rotating member is located between the two ends of the first rotating member.

3. The height-adjustable mount according to claim 1, wherein the first frame assembly comprises a first frame and a middle connecting plate coupled to the first frame, wherein:
the rotation assembly is symmetrically disposed in two groups along a first direction,
the balance assembly includes two elastic members or assemblies symmetrically disposed along the first direction, and
there is a one-to-one correspondence between the rotation assembly and the elastic members or assemblies.

4. The height-adjustable mount according to claim 1, wherein:
the balance assembly further comprising a first elastic member, wherein one end of the first elastic member connects to the first rotating member, and the other end of the first elastic member connects to the second frame assembly; and/or,
wherein the first frame assembly comprises a first frame and a middle connecting plate coupled to the first frame, and wherein the balance assembly further comprising a second elastic member, one end of the second elastic member connects to the second rotating member, and the other end of the second elastic member connects to the middle connecting plate.

5. The height-adjustable mount according to claim 1, wherein a position of a connection point of the elastic member or assembly to the first rotating member is movably arranged on the first rotating member such that a force arm length between a rotational connection point of the first rotating member to the second frame assembly and the connection point of the first rotating member to the elastic member or assembly is adjustable.

6. A support for a display device, comprising:
a second frame assembly;
a first frame assembly, which is arranged to be liftable and lowerable relative to the second frame assembly and is configured for coupling to and supporting a display device;
a balance assembly, comprising an elastic member or assembly;
a rotation assembly and an adjusting mechanism,
wherein the rotation assembly is rotatably arranged on the second frame assembly and rotatably coupled to the first frame assembly,
the elastic member or assembly is coupled to the second frame assembly at a first end and acts on the rotation assembly at a second end, the elastic member or assembly is used for providing a balancing force to the rotation assembly so that the first frame assembly can maintain a balanced state at any position, and the adjusting mechanism is used for moving the second end of the elastic member or assembly on the rotation assembly to adapt to display devices with different weights.

7. The support for a display device according to claim 6, further comprising a guide member, wherein the guide member is mounted in the second frame assembly, wherein:
the first frame assembly comprises a sliding member,
the sliding member is in sliding fit with the guide member,
the rotation assembly is used for supporting the sliding member, and
part of the sliding member extends out of the second frame assembly and is used for supporting a display device.

8. The support for a display device according to claim 7, wherein the guide member comprises two spaced apart slide rails, and the sliding member comprises a slide plate, and the slide plate is configured to slide along the slide rails.

9. The support for a display device according to claim 7, wherein the guide member is a sleeve, and the sliding member is a telescopic rod, a first end of the telescopic rod is in sliding fit with the sleeve, and a second end of the telescopic rod extends out of the second frame assembly and is used for supporting a display device.

10. The support for a display device according to claim 9, wherein the guide member is provided with an elongated slot, and the sliding member is coupled to the first frame assembly by a bolt passing through the elongated slot.

11. The support for a display device according to claim 7, wherein the guide member is a guide rod, and the sliding member is a sleeve, a first end of the sleeve is in sliding fit with the guide rod, and a second end of the sleeve extends out of the second frame assembly and is used for supporting a display device.

12. The support for a display device according to claim 7, wherein the support further comprises a limiting element, and wherein:
the limiting element is arranged on the guide member to limit a sliding range of the sliding member; and/or
the limiting element is arranged in the second frame assembly and is located below the rotation assembly to limit the rotation range of the rotation assembly.

13. The support for a display device according to claim 7, wherein:
the guide member is one piece, the sliding member is one piece, and the rotation assembly is in rotation fit with the sliding member; or,
the guide member is two pieces, the sliding member is two pieces, two sliding members are respectively in sliding fit with two guide members, the first frame assembly further comprises a first frame, the first frame is located in the second frame assembly, two sliding members are coupled to two ends of the first frame, and the rotation assembly is in rotation connection with the first frame.

14. The support for display device according to claim 6, wherein the adjusting mechanism comprises:
a moving member, the second end of the elastic member or assembly being coupled with the moving member;
an adjusting member arranged on the rotation assembly, the moving member being located between two ends of the adjusting member, the moving member moving on the adjusting member by operating the adjusting member.

15. The support for a display device according to claim 14, wherein the adjusting mechanism further comprises an operating member coupled with the adjusting member, the adjusting member configured to be driven by operating the operating member.

16. The support for a display device according to claim 15, wherein the adjusting member is a screw and is rotatably arranged on the rotation assembly, the moving member being located at a periphery of the adjusting member and threadedly engaged with the adjusting member, the moving member being slidingly engaged with the rotation assembly, the operating member for driving the adjusting member to rotate, and when the adjusting member rotates, the moving member is permitted to move relative to the rotation assembly.

17. The support for a display device according to claim 16, wherein the operating member comprises an operation element coupled with one end of the adjusting member, at least part of the operation element being exposed outside the rotation assembly and the second frame assembly; and/or,
the operating member comprises:
an operation element;
a first gear coupled to the operation element;
a second gear coupled to one end of the adjusting member, the first gear and the second gear being meshed with each other, the axis of the operation element and the axis of the adjusting member being arranged at an angle, at least one end of the operation element being exposed outside the rotation assembly.

18. The support for a display device according to claim 6, wherein the rotation assembly comprises:
a second rotating member rotatably coupled with the first frame assembly;
a first rotating member, one end of the first rotating member being rotatably coupled with the second rotating member, the other end of the first rotating member being rotatably coupled with the second frame assembly, the elastic member or assembly acting between the two ends of the first rotating member.

19. The support for a display device according to claim 6, wherein the balance assembly further comprises an auxiliary elastic mechanism, the auxiliary elastic mechanism comprising:
a second elastic member, one end of the second elastic member being rotatably connects to the second rotating member, and the other end of the second elastic member
being rotatably coupled to the first frame assembly.

20. A support for display device, comprising:
a first frame assembly, a second frame assembly, a rotation assembly and a balance assembly;
wherein the first frame assembly is slidable along the second frame assembly, the first frame assembly being provided with a mounting structure adapted to connect a display device;
one end of the rotation assembly being rotatably coupled with the second frame assembly, the other end of the rotation assembly being rotatably coupled with the first frame assembly;
the balance assembly comprising an elastic member or assembly, one end of the elastic member or assembly being coupled with the second frame assembly, the other end of the elastic member or assembly being coupled with the rotation assembly.
